(19) United States
(12) Patent Application Publication
(10) Pub. No.: US 2026/0012303 A1
(43) Pub. Date: Jan. 8, 2026

(54) UE INITIATED EARLY SRS TRIGGERING

(71) Applicant: Samsung Electronics Co., Ltd., Suwon-si (KR)

(72) Inventors: Emad Nader Farag, Flanders, NJ (US); Hongbo Si, Allen, TX (US); Marian Rudolf, Longueuil (CA); Eko Onggosanusi, Coppell, TX (US); Dalin Zhu, Allen, TX (US)

(21) Appl. No.: 19/243,421

(22) Filed: Jun. 19, 2025

Related U.S. Application Data
(60) Provisional application No. 63/668,710, filed on Jul. 8, 2024.
(60) Provisional application No. 63/677,216, filed on Jul. 30, 2024.

(51) Int. Cl. H04L 5/00; H04B 17/318; H04W 72/044; H04W 74/0833

(52) U.S. Cl. CPC H04L 5/0044; H04B 17/328; H04W 72/046; H04W 74/0833

(57) ABSTRACT

Methods and apparatuses for user equipment (UE) initiated early sounding reference signal (SRS) triggering. A method of operating a UE includes receiving a configuration related to a SRS. The configuration indicates a list of downlink (DL) signals associated with one or more cells, SRS resources, and an association between the DL signals and the SRS resources The method further includes measuring and determining a DL signal from the DL signals and determining, from the SRS resources, an SRS resource associated with the DL signal. The method further includes transmitting an uplink (UL) signal associated with the determined SRS resource and transmitting the SRS resource based on the UL signal.

### CROSS-REFERENCE TO RELATED AND CLAIM OF PRIORITY

The present application claims priority under 35 U.S.C. § 119(e) to U.S. Provisional Patent Application No. 63/668,710 filed on Jul. 8, 2024 and U.S. Provisional Patent Application No. 63/677,216 filed on Jul. 30, 2024, which are hereby incorporated by reference in their entirety.

### TECHNICAL FIELD

The present disclosure relates generally to wireless communication systems and, more specifically, the present disclosure relates to methods and apparatuses for signals and methods for user equipment (UE) initiated early sounding reference signal (SRS) triggering.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to signals and methods for UE initiated early SRS triggering.

In one embodiment, a UE is provided. The UE includes a transceiver configured to receive a configuration related to SRS. The configuration indicates a list of downlink (DL) signals associated with one or more cells, SRS resources, and an association between the DL signals and the SRS resources. The UE further includes a processor operably coupled to the transceiver. The processor is configured to measure and determine a DL signal from the DL signals and determine, from the SRS resources, an SRS resource associated with the DL signal. The transceiver is further configured to transmit an uplink (UL) signal associated with the determined SRS resource and transmit the SRS resource based on the UL signal.

In another embodiment, a base station (BS) is provided. The BS includes a processor and a transceiver operably coupled to the processor. The transceiver is configured to transmit a configuration related to a SRS. The configuration indicates a list of DL signals associated with one or more cells, SRS resources, and an association between the DL signals and the SRS resources. The transceiver is further configured to receive an UL signal associated with an SRS resource and receive the SRS resource based on the UL signal.

In yet another embodiment, a method of operating a UE is provided. The method includes receiving a configuration related to SRS. The configuration indicates a list of DL signals associated with one or more cells, SRS resources, and an association between the DL signals and the SRS resources. The method further includes measuring and determining a DL signal from the DL signals and determining, from the SRS resources, an SRS resource associated with the DL signal. The method further includes transmitting an UL signal associated with the determined SRS resource and transmitting the SRS resource based on the UL signal.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a diagram of an example synchronization signal/physical broadcast channel (SS/PBCH) block according to embodiments of the present disclosure;

FIG. 8A illustrates a flowchart of an example contention based random access (CBRA) procedure according to embodiments of the present disclosure;

FIG. 8B illustrates a flowchart of an example contention free random access (CFRA) procedure according to embodiments of the present disclosure;

FIG. 9A illustrates a flowchart of an example CBRA procedure according to embodiments of the present disclosure;

FIG. 9B illustrates a flowchart of an example CFRA procedure according to embodiments of the present disclosure;

FIG. 10 illustrates a flowchart of an example procedure for triggering SRS transmission according to embodiments of the present disclosure;

FIG. 11 illustrates a flowchart of an example procedure for RRC setup/configuration according to embodiments of the present disclosure;

FIGS. 12A and 12B illustrate a flowcharts of example procedures for triggering early SRS according to embodiments of the present disclosure;

FIGS. 13A and 13B illustrate a flowcharts of example procedures for triggering early SRS according to embodiments of the present disclosure;

FIG. 14 illustrates a flowchart of an example procedure for transmitting SRS according to embodiments of the present disclosure;

FIG. 15 illustrates a flowchart of an example procedure for transmitting early SRS according to embodiments of the present disclosure;

FIG. 16 illustrates a flowchart of an example procedure for transmitting early SRS according to embodiments of the present disclosure;

FIG. 17 illustrates example SRS transmission instances according to embodiments of the present disclosure;

FIG. 18 illustrates an example spatial filter according to embodiments of the present disclosure;

FIG. 19 illustrates a diagram of an example early SRS area (ESA) according to embodiments of the present disclosure; and

FIG. 20 illustrates a diagram of an example ESA according to embodiments of the present disclosure.

### DETAILED DESCRIPTION

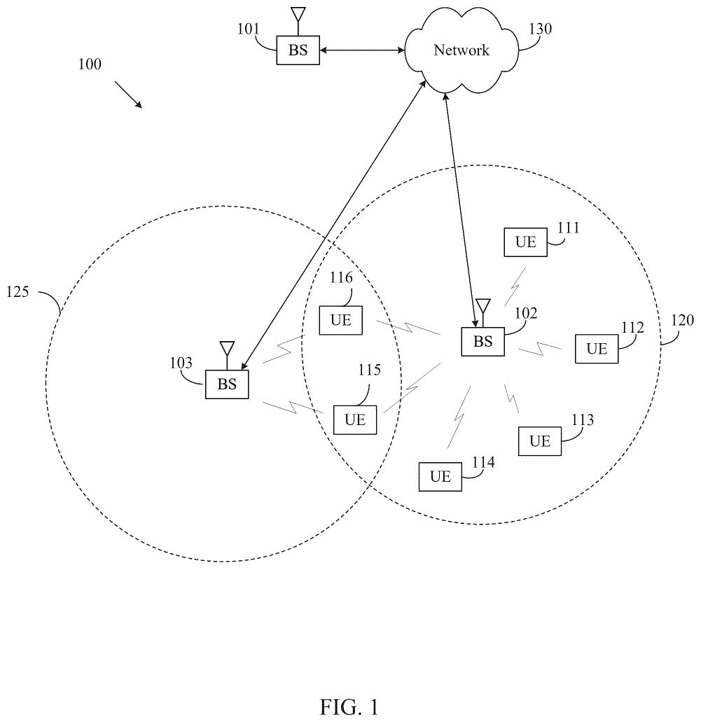

FIGS. 1-20, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1]3GPP TS 38.211 v18.3.0, “NR; Physical channels and modulation;” [REF 2]3GPP TS 38.212 v18.3.0, “NR; Multiplexing and Channel coding;” [REF 3]3GPP TS 38.213 v18.3.0, “NR; Physical Layer Procedures for Control;” [REF 4]3GPP TS 38.214 v18.3.0, “NR; Physical Layer Procedures for Data;” [REF 5]3GPP TS 38.321 v18.2.0, “NR; Medium Access Control (MAC) protocol specification;” and [REF 6]3GPP TS 38.331 v18.2.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103 (collectively forming a BS system). The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for supporting UE initiated early SRS triggering. In certain embodiments, one or more of the gNBs 101-103 include circuitry, programing, or a combination thereof to support signaling and methods for UE initiated early SRS triggering.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

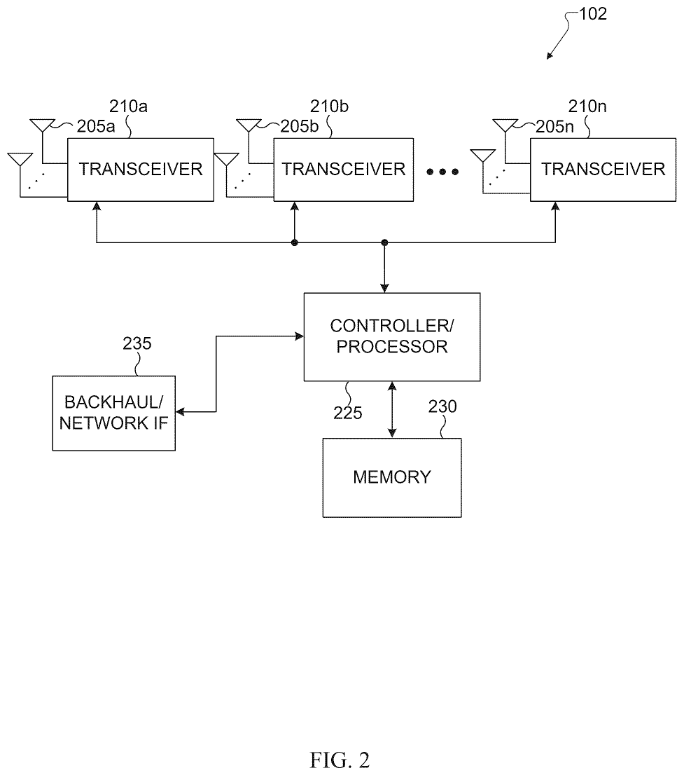

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting signaling and methods for UE initiated early SRS triggering. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

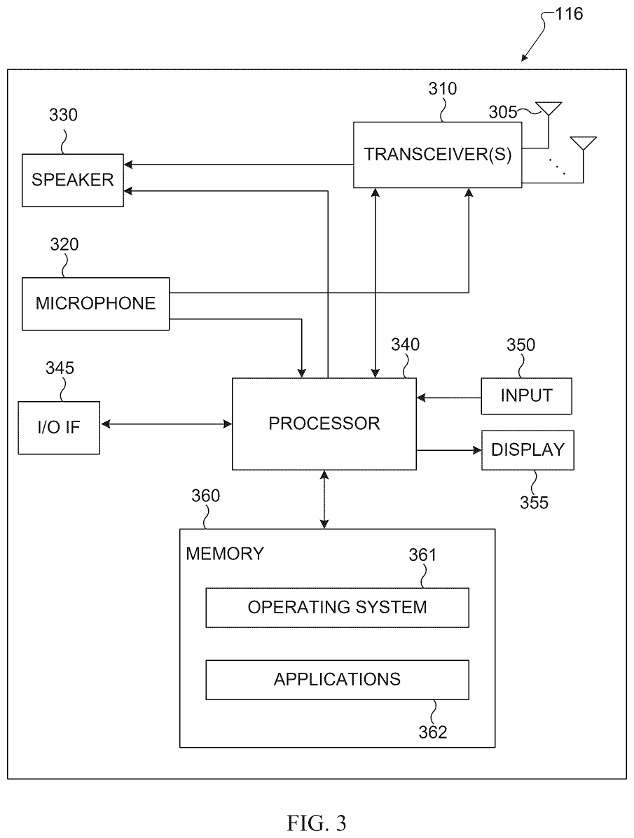

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to utilize and/or identify signals and methods for UE initiated early SRS triggering as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

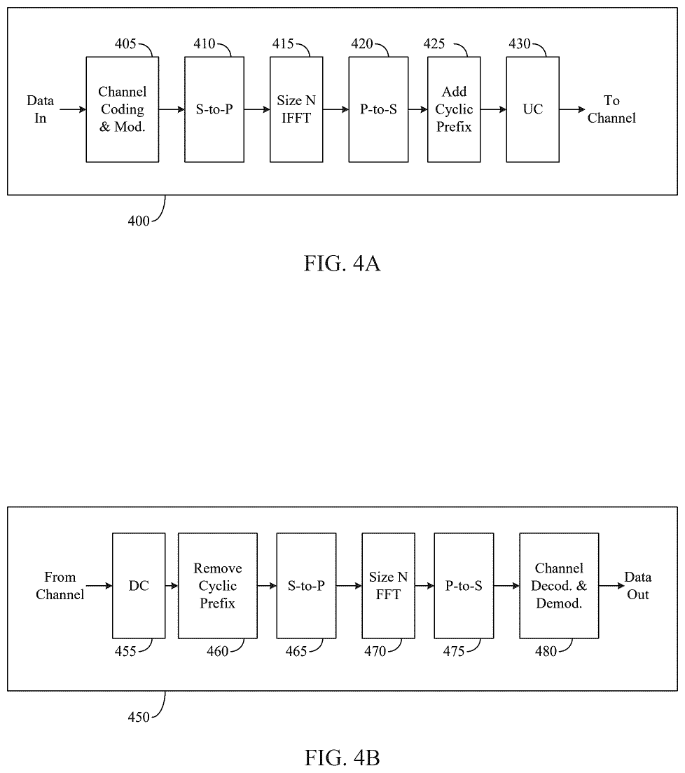

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 performs actions for signaling and methods for UE initiated early SRS triggering as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In this disclosure, a beam can be determined by any of,
A TCI state, that establishes a quasi-colocation (QCL) relationship or spatial relation between a source reference signal (e.g. synchronization signal/physical broadcast channel (PBCH) block (SSB) and/or channel state information reference signal (CSI-RS)) and a target reference signal
A spatial relation information that establishes an association to a source reference signal, such as SSB or CSI-RS or sounding reference signal (SRS).

In either case, the ID of the source reference signal or TCI state or spatial relation identifies the beam.

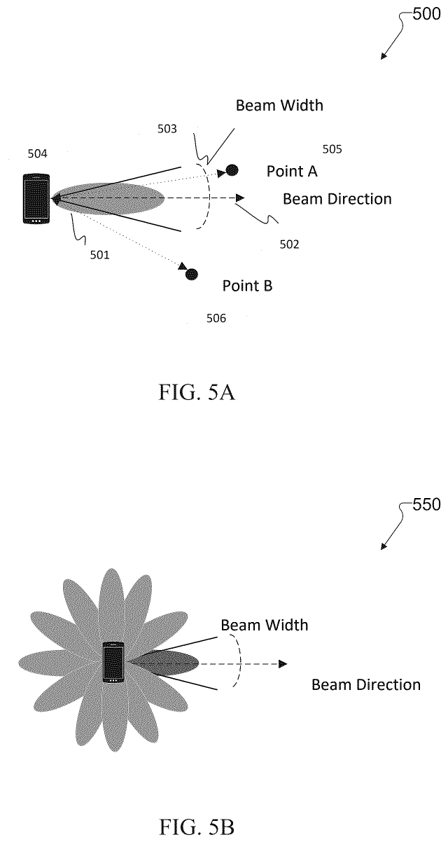

As illustrated in FIG. 5A, in a wireless system 500, a beam 501 for a device 504 can be characterized by a beam direction 502 and a beam width 503. For example, the device 504 (or UE 116) transmits RF energy in a beam direction 502 and within a beam width 503. The device 504 receives RF energy in a beam direction 502 and within a beam width 503. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While in FIG. 5B, for illustrative purposes, a beam is in 2D, it should be apparent to those skilled in the art, that a beam can be 3D, where a beam can be transmitted to or received from any direction in space.

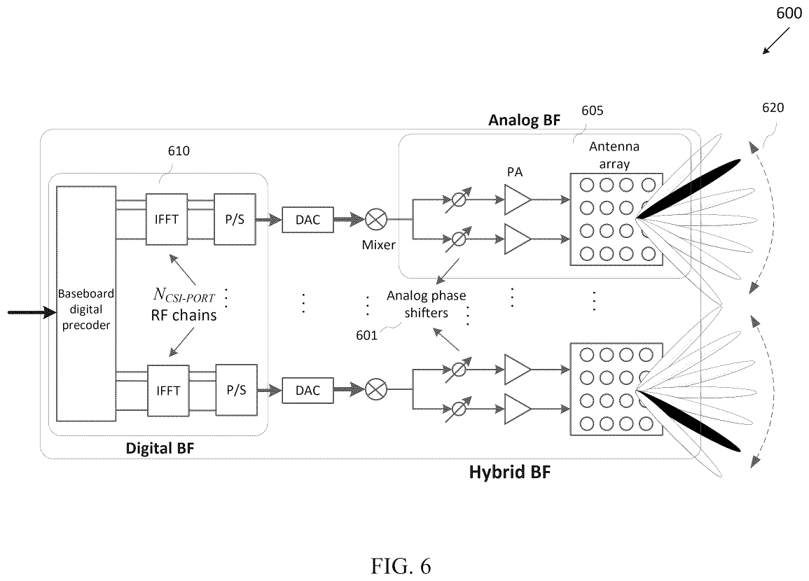

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only, and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for purposes of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O₂ absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while the figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

Rel-17 introduced the unified TCI framework, where a unified or master or main or indicated TCI state is signaled to the UE. The unified or master or main or indicated TCI state can be one of:
1. In case of joint TCI state indication, wherein a same beam is used for DL and UL channels, a joint TCI state that can be used at least for UE-dedicated DL channels and UE-dedicated UL channels.
2. In case of separate TCI state indication, wherein different beams are used for DL and UL channels, a DL TCI state that can be used at least for UE-dedicated DL channels.
3. In case of separate TCI state indication, wherein different beams are used for DL and UL channels, a UL TCI state that can be used at least for UE-dedicated UL channels.

The unified (master or main or indicated) TCI state is TCI state of UE-dedicated reception on physical downlink shared channel (PDSCH)/physical downlink control channel (PDCCH) or dynamic-grant/configured-grant based physical uplink shared channel (PUSCH) and dedicated physical uplink control channel (PUCCH) resources.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state can be associated with a TRP of a cell having a PCI different from the PCI of the serving cell).

Quasi-co-location (QCL) relation, can be quasi-location with respect to one or more of the following relations [[REF 4]—section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter}

In addition, quasi-co-location relation and source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g. non-UE dedicated channel and sounding reference signal (SRS).

A UE (e.g., the UE 116) is indicated a TCI state by MAC CE when the MAC CE activates one TCI state code point. The UE applies the TCI state code point after a beam application time from the corresponding hybrid automatic repeat request acknowledgement (HARQ-ACK) feedback. A UE is indicated a TCI state by a DL related downlink control information (DCI) format (e.g., DCI Format 1_1, or DCI format 1_2), wherein the DCI format includes a “transmission configuration indication” field that includes a TCI state code point out of the TCI state code points activated by a MAC CE. A DL related DCI format can be used to indicate a TCI state when the UE is activated with more than one TCI state code points. The DL related DCI format can be with a DL assignment for PDSCH reception or without a DL assignment. A TCI state can also be indicated in a purpose designed channel or DCI Format for TCI state indication. A TCI state (TCI state code point) indicated in a DL related DCI format or purpose design channel or DCI Format for TCI state indication is applied after a beam application time from the corresponding HARQ-ACK feedback.

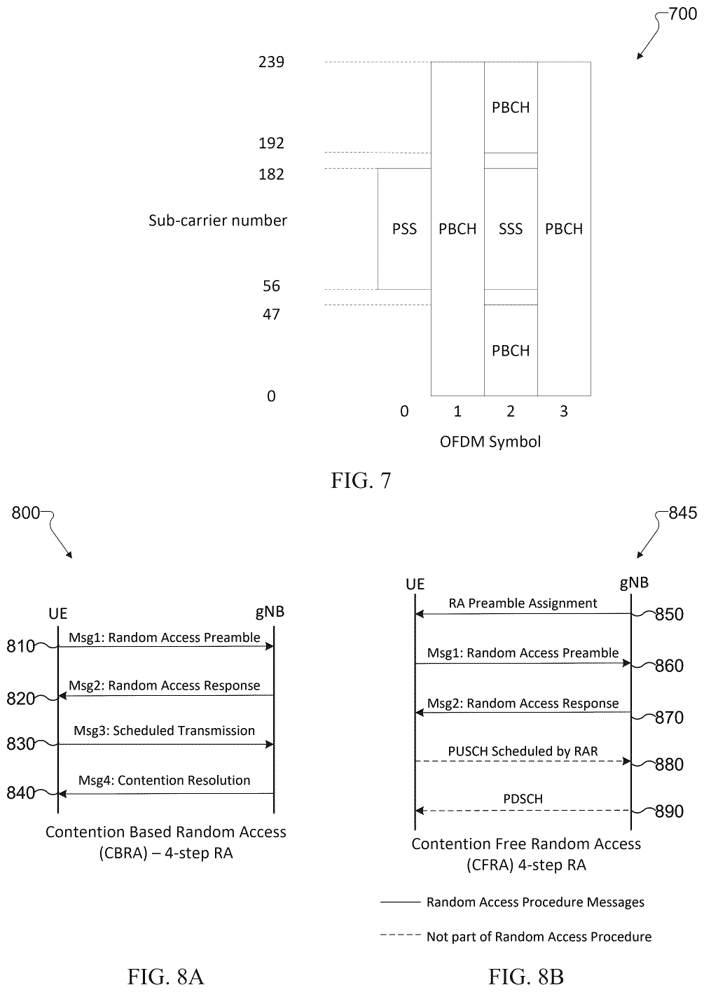

FIG. 7 illustrates a diagram of an example SS/PBCH block 700 according to embodiments of the present disclosure. For example, SS/PBCH block 700 can be utilized by any of the UEs 111-116 of FIG. 1. This example is for illustration only and other embodiments can be used without departing from the scope of the present disclosure.

In 5G/NR, a UE performs the cell search procedure to acquire time and frequency synchronization with a cell and to detect the physical layer Cell ID of the cell. To perform cell search, the UE receives the following signals and channel: (1) the primary synchronization signal (PSS), (2) the secondary synchronization signal (SSS) and (3) the physical broadcast channel (PBCH). With reference to FIG. 7, a primary synchronization signal (PSS)/secondary synchronization signal (SSS)/PBCH block (SS/PBCH block) is referred to as SSB and includes 4 consecutive symbols, and 20 resource blocks (RBs) (240 subcarriers), as illustrated in FIG. 7.

SSBs are organized in groups (or bursts) of up to N SSBs, transmitted within half a frame (5 ms), each SSB within the group or burst has an index i, where i=0, 1, . . . , N−1, within each group or burst of SSBs, the SSBs are time-division multiplexed and arranged in increasing order of i, with increasing time. For carrier frequencies less than or equal to 3 GHz, N=4. For carrier frequencies in FR1 that are larger than 3 GHz, N=8. For carrier frequencies in FR2, N=64. The SSB indices actually transmitted are provided by ssb-PositionsInBurst in system information block one (SIB1) or in ServingCellConfigCommon or in SSB-MTC-AdditionalPCI or in LTM-SSB-Config.

SSBs are transmitted periodically, where the allowed periodicities are {5, 10, 20, 40, 80, 160} ms. In addition to cell search, SSBs can also be used for beam management related procedures, such as new beam acquisition, beam measurements, and beam failure detection and recovery. Each SSB with index i can be associated with a spatial domain filter (or beam).

NR introduced a physical random access channel (PRACH) to be used, among other cases, when the UE wants to communicate with the network (e.g., the network 130) and doesn't have uplink resources. For example, the physical random access channel can be used during initial access. The PRACH includes a preamble format comprising one or more preamble sequences transmitted in a PRACH Occasion (RO).

NR supports four different preamble sequence lengths:
Sequence length 839 used with sub-carrier spacings 1.25 kHz and 5 kHz with unrestricted or restricted sets.
Sequence length 139 used with sub-carrier spacings 15 kHz, 30 kHz, 60 kHz, and 120 kHz with unrestricted sets.
Sequence length 571 used with sub-carrier spacing 30 kHz with unrestricted sets.
Sequence length 1151 used with sub-carrier spacing 15 kHz with unrestricted sets.

Random access channel (RACH) preambles are transmitted in time-frequency resources PRACH Occasions (ROs). Each RO determines the time and frequency resources in which a preamble is transmitted, the resources allocated to an RO in the frequency domain (e.g., number of resource blocks (RBs)) and the resource allocated to an RO in the time domain (e.g., number of OFDMA symbols or number of slots), depend on the preamble sequence length, sub-carrier spacing of the preamble, sub-carrier spacing of the PUSCH in the UL BWP, and the preamble format. Multiple PRACH Occasions can be FDMed in one time instance. This is indicated by higher layer parameter msg1-FDM. The time instances of the PRACH Occasions are determined by the higher layer parameter prach-ConfigurationIndex, and Tables 6.3.3.2-2, 6.3.3.2-3, and 6.3.3.2-4 of [REF 1]v18.1.0.

SSBs are associated with ROs. The number of SSBs associated with one RO can be indicated by higher layer parameters such as ssb-perRACH-OccasionAndCB-PreamblesPerSSB and ssb-perRACH-Occasion. The number of SSBs per RO can be {⅛,¼,½,1,2,4,8,16}. When the number of SSBs per RO is less than 1, multiple ROs are associated with the same SSB index. SS/PBCH block indexes provided by ssb-PositionsInBurst in SIB1 or in ServingCellConfigCommon are mapped to valid PRACH occasions in the following order [[REF 3]v18.1.0]:
First, in increasing order of preamble indexes within a single PRACH occasion.
Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

The association period starts from frame 0 for mapping SS/PBCH block indexes to PRACH Occasions.

FIG. 8A illustrates a flowchart of an example contention-based random access (CBRA) procedure 800 according to embodiments of the present disclosure. For example, CBRA procedure 800 can be performed by the UE 116 and the gNB 102 and/or network 130 in the wireless network 100 of FIG. 1. This example is for illustration only and other embodiments can be used without departing from the scope of the present disclosure.

The procedure begins in 810, a UE transmits a Msg1: random access preamble to a gNB. In 820, the gNB transmits a Msg2: random access response to the UE. In 830, the UE transmits a Msg3: scheduled transmission to the gNB. In 840, the gNB transmits Msg4: content resolution to the UE.

FIG. 8B illustrates a flowchart of an example contention-free random access (CFRA) procedure 845 according to embodiments of the present disclosure. For example, CFRA procedure 845 can be performed by the UE 116 and the gNB 103 and/or network 130 in the wireless network 100 of FIG. 1. This example is for illustration only and other embodiments can be used without departing from the scope of the present disclosure.

The procedure begins in 850, a gNB transmits a RA preamble assignment to a UE. In 860, the UE transmits a Msg1: random access preamble to the gNB. In 870, the gNB transmits a Msg2: random access response to the UE. In 880, the UE may transmit a PUSCH scheduled by random access response (RAR) to the gNB. In 890, gNB may transmit PDSCH to the UE.

A random access procedure can be initiated by a PDCCH order, by the MAC entity, or by RRC.

There are two types of random access procedures, type-1 random access procedure and type-2 random access procedure.

With reference to FIG. 8, Type-1 random access procedure also known as four-step random access procedure (4-step RACH) is shown;
In step 1, the UE transmits a random access preamble, also known as Msg1, to the gNB. The gNB attempts to receive and detect the preamble.
In step 2, the gNB upon receiving the preamble transmits a random access response (RAR), also known as Msg2, to the UE including, among other fields, a time adjustment (TA) command and a RAR uplink grant for a subsequent PUSCH transmission.
In step 3, the UE after receiving the RAR, transmits a PUSCH transmission scheduled by the grant of the RAR and time adjusted according to the TA received in the RAR. Msg3 or the PUSCH scheduled by the RAR UL grant can include the RRC setup request message.
In step 4, the gNB upon receiving the RRC setup message, allocates downlink and uplink resources that are transmitted in a downlink PDSCH transmission to the UE.

After the last step, the UE can proceed with reception and transmission of data traffic.

Type-1 random access procedure (4-step RACH) can be contention based random access (CBRA) or contention free random access (CFRA). The CFRA procedure ends after the random access response, the following messages are not part of the random access procedure. For CFRA, in step 0, the gNB indicates to the UE the preamble(s) to use.

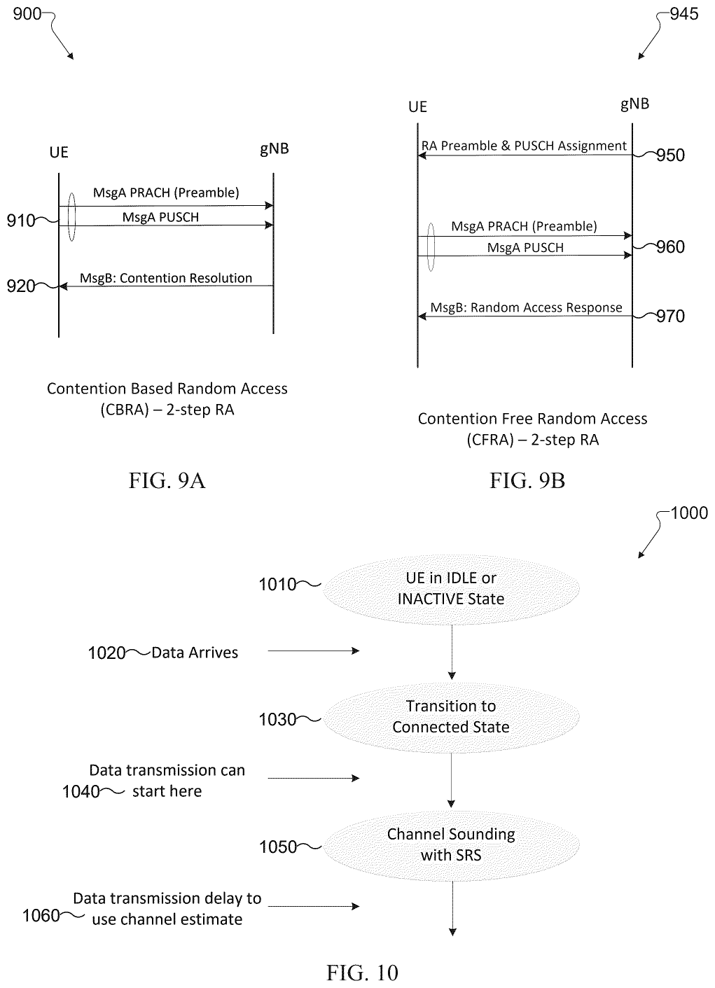

FIG. 9A illustrates a flowchart of an example CBRA procedure 900 according to embodiments of the present disclosure. For example, CBRA procedure 900 can be performed by the UE 115 and the gNB 102 and/or network 130 in the wireless network 100 of FIG. 1. This example is for illustration only and other embodiments can be used without departing from the scope of the present disclosure.

The procedure begins in 910, a UE transmits MsgA PRACH (preamble) and MsgA PUSCH to a gNB. In 920, the gNB transmits MsgB: contention resolution to the UE.

FIG. 9B illustrates a flowchart of an example CFRA procedure 945 according to embodiments of the present disclosure. For example, CFRA procedure 945 can be performed by the UE 115 and the gNB 103 and/or network 130 in the wireless network 100 of FIG. 1. This example is for illustration only and other embodiments can be used without departing from the scope of the present disclosure.

The procedure begins in 950, a gNB transmits a RA preamble and PUSCH assignment to a UE. In 960, the UE transmits MsgA PRACH (preamble) and MsgA PUSCH to the gNB. In 970, the gNB transmits MsgB: random access response to the UE.

Rel-16 introduced a new random access procedure; Type-2 random access procedure, also known as 2-step random access procedure (2-step RACH), with reference to FIG. 9, that combines the preamble and PUSCH transmission into a single transmission from the UE to the gNB, which is known as MsgA. Similarly, the RAR and the PDSCH transmission (e.g., Msg4) are combined into a single downlink transmission from the gNB to the UE, which is known as MsgB.

A random access procedure can be triggered for initial access from the RRC_IDLE state. During this procedure, a UE (e.g., the UE 116) identifies an SS/PBCH block with index i and with an reference signal received power (RSRP) that exceeds a threshold. The RSRP threshold for SSB selection for RACH resource association is indicated by the network. The UE selects a RO and a preamble within the RO associated with SS/PBCH block index i. The UE transmits a PRACH using the selected RO/preamble. The UE monitors and receives the random access response (RAR), by attempting to detect a DCI format 1_0 with cyclic redundancy check (CRC) scrambled by a corresponding random access radio network temporary identifier (RA-RNTI) during a window controlled by higher layers. If the UE does not detect the DCI format 1_0 with CRC scrambled by the corresponding RA-RNTI within the RAR window, the UE may retransmit PRACH. If the UE detects the DCI format 1_0 with CRC scrambled by the corresponding RA-RNTI, the UE receives a RAR UL grant for the scheduling of a PUSCH. The UE transmits the PUSCH according to the RAR UL grant. In response to the PUSCH transmission scheduled by a RAR UL grant, when a UE has not been provided a cell RNTI (C-RNTI), the UE attempts to detect a DCI format 1_0 with CRC scrambled by a corresponding temporary cell-radio network temporary identifier (TC-RNTI) scheduling a PDSCH that includes a UE contention resolution identity. The spatial domain filters (beams) identified during initial access, are used for subsequent transmissions and receptions to/from the UE until a single TCI state is configured or activated or indicated to the UE. For downlink receptions when a UE does not have the TCI state, the spatial domain filter is that associated with the SS/PBCH block index identified during initial access. For uplink transmissions when a UE does not have the TCI state, the spatial domain filter is that used for PUSCH scheduled by the RAR UL grant.

Sounding reference signal is an uplink reference signal that is used for sounding (i.e., channel state or quality estimation) the uplink channel between the UE and the gNB (e.g., the BS 102). In case of reciprocity between UL and DL, the channel sounding of the uplink channel can also be used for link adaptation and precoding on the downlink channel from the gNB to the UE. SRS is transmitted independent of data transmissions on the uplink. The SRS usage can be one of: beamManagement, codebook, nonCodebook, antennaSwitching, this is in addition to SRS for positioning.

In NR, SRS resources are configured by the network (e.g., the network 130) for example as part of RRC setup or RRC reconfiguration. SRS resources are configured in SRS resource set. An SRS resource set includes a set of SRS resource, and defines the following parameters: (1) resourceType, which determine the time domain behavior of SRS, SRS can be aperiodic, semi-persistent or periodic. (2) usage, which can be one of: beamManagement, codebook, nonCodebook or antennaSwitching. (3) information related to power control and TCI state.

The configuration of the SRS resource includes the following: (1) information related to the transmission comb, including comb size, comb offset and cyclic shift. (2) Information related to time domain resource mapping including starting symbol within a slot, number of SRS symbols and repetition factor. (3) information related to frequency domain including freqDomainPosition N_RRC, freqDomainShift n_shift, and frequency hopping parameters c-SRS, b-SRS, and b-hop. (4) Information related to group or sequence hopping, whether one of them or neither is enabled. (5) for periodic and semi-persistent SRS, the periodicity and offset of the SRS resource. (6) Sequence ID. (7) Information related to the TCI state or spatial relation info.

In 5G NR, a UE can transmit a sounding reference signal (SRS). A SRS resource is configured by higher layer IE SRS-Resource.

The SRS sequence is a low peak-to-average power ratio (PAPR) sequence of length

$${N}_{ZC} = {M}_{sc , b}^{SRS}$$

given by:

$${r}^{( p )} ( n , {l}^{′} ) = {r}_{u , v}^{( α , δ )} ( n ) = {e}^{jαn} {\overline{r}}_{u , v} ( n ) , 0 \leq n < {M}_{ZC}$$

where

$${M}_{ZC} = {mN}_{sc}^{RB} / {2}^{δ} , δ = log ( {K}_{TC} ) ,$$

with K_{TC} being the transmission comb number is provided in higher layer IE transmissionComb, K_{TC}∈{2,4,8}. l′ is the SRS symbol within a SRS resource of a slot,

$${l}^{′} ∈ \{ 0 , 1 , ... , {N}_{symb}^{SRS} - 1 \} , {N}_{symb}^{SRS}$$

is the number of SRS symbols in a slot. The cyclic shift αᵢ for antenna port pᵢ is given by

$${α}_{i} = 2 π \frac{{n}_{SRS}^{cs , i}}{{n}_{SRS}^{cs , max}} , and {n}_{SRS}^{cs , i} = ( {n}_{SRS}^{cs} + \frac{{n}_{SRS}^{cs , max} ( {p}_{i} - 1000 )}{{N}_{ap}^{SRS}} ) mod {n}_{SRS}^{cs , max}$$

with

$${n}_{SRS}^{cs}$$

being provided by higher layer in IE transmissionComb,

$${n}_{SRS}^{cs , max}$$

depends on K_{TC} as illustrated in Table 1.

TABLE 1

| K_{TC} | ${n}_{SRS}^{cs , max}$ |
|---|---|
| 2 | 8 |
| 4 | 12 |
| 8 | 6 |

u is the group number u∈{0, 1, . . . , 29}, v is the base sequence number, with v∈{0}, if 6≤N_{ZC}≤60 and ∈{0,1}, if 60<N_{ZC}. The base sequence, r̅_{u,v}(n), is generated as follows:

| | |
|---|---|
| 1. | For N_{ZC} ∈ {6, 12, 18, 24}, r̅_{u,v}(n) = e^{jϕ(n)π/4}, with 0 ≤ n < M_{ZC} − 1. |
| | ϕ(n) is given by Tables 5.2.2.2-1 to 5.2.2.2-4 of [REF 1]. |
| 2. | $For {N}_{Z C} = 30 , {\overline{r}}_{u , v} ( n ) = {e}^{- j \frac{π ( u + 1 ) ( n + 1 ) ( n + 2 )}{31}} , with 0 \leq n < {M}_{Z C} - 1 .$ |
| 3. | $For {N}_{Z C} \geq 30 , {\overline{r}}_{u , v} ( n ) = {x}_{q} ( n mod {N}_{Z C} ) , {x}_{q} ( n ) = {e}^{- j \frac{π q m ( m + 1 )}{{N}_{ZC}}} . {N}_{Z C}$ |
| | is the largest prime number less than |
| | ${M}_{ZC} . q = ⌊ \overline{q} + 1 / 2 ⌋ + v \cdot {( - 1 )}^{⌊ 2 \overline{q} ⌋} . \overline{q} = {N}_{ZC} \frac{u + 1}{31} .$ |

The sequence group u is given by:

$$u = ( {f}_{gh} ( {n}_{s , f}^{μ} , {l}^{′} ) + {n}_{ID}^{SRS} ) .$$

### Where,

$${n}_{ID}^{SRS}$$

is provided by higher layer parameter sequenceID, with

$${n}_{ID}^{SRS} ∈ \{ 0 , 1 , ... , 65535 \} .$$

Higher layer parameter groupOrSequenceHopping determines the values of u and v:
if groupOrSequenceHopping equals ‘neither’, neither group, nor sequence hopping shall be used and

$${f}_{gh} ( {n}_{s , f}^{μ} , {l}^{′} ) = 0 ,$$

and v=0.
if groupOrSequenceHopping equals ‘groupHopping’, group hopping but not sequence hopping is used and

$$v = 0 , and {f}_{gh} ( {n}_{s , f}^{μ} , {l}^{′} ) = ( {\sum }_{m = 0}^{7} c ( 8 ( {n}_{s , f}^{μ} {N}_{symb}^{slot} + {l}_{0} + {l}^{′} ) + m ) \cdot {2}^{m} ) mod 30 ,$$

$${N}_{symb}^{slot}$$

is the number of symbols in a slots, l₀ is the first SRS symbols in the slot, and c(n) a length-31 Gold sequence defined as c(n)=(x₁(n+N_{c})+x₂(n+N_{c}))mod 2, with N_{c}=1600, x₁(n+31)=(x₁(n+3)+x₁(n))mod 2, x₂(n+31)=(x₂(n+3)+x₂(n+2)+x₂(n+1)+x₂(n))mod 2, the first m-sequence is initialized with x₁(0)=1, and x₁(n)=0, for n=1 . . . 30. The second m-sequence is initialized with cᵢₙᵢₜ, where

$${c}_{init} = {n}_{ID}^{SRS}$$

if groupOrSequenceHopping equals ‘sequenceHopping’, sequence hopping but not group hopping is used and

$${f}_{gh} ( {n}_{s , f}^{μ} , {l}^{′} ) = 0 and$$

$$v = \{ \begin{matrix}c ( {n}_{s , f}^{μ} {N}_{symb}^{slot} + {l}_{0} + {l}^{′} ) & {M}_{sc , b}^{SRS} \geq 6 {N}_{sc}^{RB} \\ 0 & otherwise\end{matrix}$$

$${N}_{symb}^{slot}$$

is the number of symbols in a slots, l₀ is the first SRS symbols in the slot, and c(n) a length-31 Gold sequence as previously defined.

The SRS sequence, r^{(p)}(n, l′), is mapped to resource elements

$${a}_{k , l}^{( p )}$$

a within a slot, where k is the sub-carrier frequency, l is the symbol number within the slot and p is the antenna port, where for SRS there is one antenna port, given by

$${a}_{k , l}^{( p )} = {β}_{SRS} {r}^{( p )} ( {k}^{′} , {l}^{′} )$$

$$l = {l}^{′} + {l}_{0}$$

where,
β_{SRS} is a scaling factor,

$${k}^{′} = 0 , 1 , ... , {M}_{sc , b}^{SRS} - 1 , {M}_{sc , b}^{SRS} = {m}_{SRS , b} {N}_{sc}^{RB} / {K}_{TC} ,$$

m_{SRS,b} is provided by Table 6.4.14.3-1 of [REF 1], and

$${l}^{′} = 0 , 1 , ... , {N}_{symb}^{SRS} - 1.$$

l=l′+l₀, with l₀ the first SRS symbols in the slot, where l₀ ∈{0, 1, . . . , 13}.

$$k = {K}_{TC} {k}^{′} + {k}_{0}^{( {p}_{i} )} ,$$

K_{TC} is the transmission comb number as previously described,

$${k}_{0}^{( p )} = {\overline{k}}_{0}^{( p )} + {\sum }_{b = 0}^{{B}_{SRS}} {K}_{TC} {M}_{sc , b}^{SRS} {n}_{b} ,$$

$${\overline{k}}_{0}^{( {p}_{i} )} = {n}_{shift} {N}_{sc}^{RB} + ( {k}_{TC}^{( {p}_{i} )} + {k}_{offset}^{{l}^{′}} ) mod {K}_{TC} ,$$

$${k}_{TC}^{( {p}_{i} )} = \{ \begin{matrix}( {\overline{k}}_{TC} + {K}_{TC} / 2 ) mod {K}_{TC} & \begin{matrix}if {n}_{SRS}^{cs} ∈ \{ \frac{{n}_{SRS}^{cs , max}}{2} , … , {n}_{SRS}^{cs , max} - 1 \} and \\ {N}_{ap}^{SRS} = 4 and {p}_{i} ∈ \{ 1001 , 1003 \}\end{matrix} \\ {\overline{k}}_{TC} & otherwise\end{matrix}$$

k̅_{TC} is the transmission comb offset included within higher layer IE transmissionComb, with \hat{k}_{TC}∈{0, 1, . . . , K_{TC}−1},

$${k}_{offset}^{{l}^{′}}$$

is a symbol dependent sub-carrier offset given by Table 2, n_{shift} is given by higher layer parameter freqDomainShift and it adjusts the frequency allocation with respect to a reference point. If

$${N}_{BWP}^{start} \leq {n}_{shift}$$

the reference point for

$${k}_{0}^{( p )}$$

is sub-carrier 0 in common resource block 0, otherwise the reference point is the lowest subcarrier of the BWP. n_{b} is a frequency positioning index. n_{b} is given by:

$${n}_{b} = ⌊ \frac{4 {n}_{RRC}}{{m}_{SRS , b}} ⌋ mod {N}_{b}$$

n_{RRC} is given by higher layer parameter freqDomainPosition, and m_{SRS,b} and N_{b} are determined by Table 6.4.14.3-1 of [REF 1] with b=B_{SRS} and the configured value of C_{SRS}.

TABLE 2

| | ${k}_{offset}^{0} , {k}_{offset}^{1} , … , {k}_{offset}^{{N}_{symb}^{SRS} - 1}$ | | | | |
|---|---|---|---|---|---|
| K_{TC} | ${N}_{s y m b}^{S R S} = 1$ | ${N}_{symb}^{SRS} = 2$ | ${N}_{symb}^{SRS} = 4$ | ${N}_{symb}^{SRS} = 8$ | ${N}_{symb}^{SRS} = 12$ |
| 2 | 0 | 0, 1 | 0, 1, 0, 1 | — | — |
| 4 | — | 0, 2 | 0, 2, 1, 3 | 0, 2, 1, 3, 0, 2, 1, 3 | 0, 2, 1, 3, 0, 2, 1, 3, 0, 2, 1, 3 |
| 8 | — | — | 0, 4, 2, 6 | 0, 4, 2, 6, 1, 5, 3, 7 | 0, 4, 2, 6, 1, 5, 3, 7, 0, 4, 2, 6 |

In NR, paging is used to alert idle and inactive UEs of incoming calls, messages and data. Paging is used to trigger RRC setup (e.g., RRC setup request or RRC connection resumption).

Paging is transmitted over the paging channel (PCH). The paging message includes a paging record list, which is a list of UEs being paged, each identified by a temporary mobile subscriber identity (TMSI) or an inactive RNTI (I-RNTI). The 5G S-Temporary Mobile Subscription Identifier (5G-S-TMSI), a temporary UE identity provided by the 5GC which uniquely identifies the UE within the tracking area. The I-RNTI is used to identify the suspended UE context of a UE in RRC_INACTIVE.

The following messages describe the contents of a paging message:

| | |
|---|---|
| PCCH-Message ::= | SEQUENCE { |
| message | PCCH-Message Type |

}

| | |
|---|---|
| PCCH-Message Type ::= | CHOICE { |
| c1 | CHOICE { |
| paging | Paging, |

```
    spare1 NULL
  },
```

| | |
|---|---|
| messageClassExtension | SEQUENCE { } |

}

| Paging ::= | SEQUENCE { | |
|---|---|---|
| pagingRecordList | PagingRecordList | OPTIONAL, -- |

Need N

| | | |
|---|---|---|
| lateNonCriticalExtension | OCTET STRING | OPTIONAL, |
| nonCriticalExtension | Paging-v1700-IEs | OPTIONAL |

}

| | |
|---|---|
| PagingRecordList ::= | SEQUENCE (SIZE(1..maxNrofPageRec)) OF PagingRecord |
| PagingRecord ::= | SEQUENCE { |
| ue-Identity | PagingUE-Identity, |
| accessType | ENUMERATED {non3GPP} OPTIONAL, -- Need N |

...
}

| | |
|---|---|
| PagingUE-Identity ::= | CHOICE { |
| ng-5G-S-TMSI | NG-5G-S-TMSI, |
| fullI-RNTI | I-RNTI-Value, |

...
}

| | |
|---|---|
| NG-5G-S-TMSI ::= | BIT STRING (SIZE (48)) |
| I-RNTI-Value ::= | BIT STRING (SIZE(40)) |

A UE may use Discontinuous Reception (DRX) in RRC_IDLE and RRC_INACTIVE state in order to reduce power consumption. The UE monitors one paging occasion (PO) per DRX cycle, T. Where, a PO is a set of PDCCH monitoring occasions and can include multiple time slots where paging DCI can be sent. A Paging Frame (PF) is one Radio Frame and may contain one or multiple PO(s) or starting point of a PO.

The PF and PO for paging are determined by the following equations:
system frame number (SFN) of the PF is determined by: (SFN+PF_offset)mod T=(T div N)*(UE_ID mod N)
The index i_s of the PO is determined by: i_s=floor (UE_ID/N)mod Ns

### Where,

T is the DRX cycle of the UE, determined by the shortest of the UE specific DRX value(s) and a default DRX value included in SIB1. (1) For CN-initiated paging, a default cycle is broadcast in system information. (2) For CN-initiated paging, a UE specific cycle can be configured via non access stratum (NAS) signaling. (3) For RAN-initiated paging, a UE-specific cycle is configured via RRC signaling. A UE in RRC_IDLE uses the shortest of (1) and (2). A UE in RRC_INACTIVE uses the shortest of (1), (2) and (3).
N is a number of total paging frames in T, provided by nAndPagingFrameOffset in SIB1.
Ns is a number of paging occasions for a PF, provided by ns in SIB1
PF_offset is an offset used for PF determination, provided by nAndPagingFrameOffset in SIB1.
UE_ID: 5G-S-TMSI mod 1024

To minimize the probability of paging false alarms, which occur when a UE decodes the PCH due to another UE assigned to the same PO being paged, UEs assigned to the same PO are divided into sub-groups, a DCI carrying a paging early indication (PEI) is transmitted before the corresponding PO to indicate the sub-groups with paging messages in the PO. A UE that is not in the indicated sub-groups indicated by the PEI doesn't decode the corresponding PO. There can be up to 8 sub-groups. The subgroups can be CN controlled sub-groups (determined by the access and mobility function (AMF)), and/or UE-ID based sub-groups.

DCI format 2_7 is used for notifying the paging early indication and tracking reference signal (TRS) availability indication for one or more UEs. DCI Format 2_7 has a CRC scrambled by PEI_RNTI. DCI Format 2_7 includes: (1) a paging indication field of size

$${N}_{PO}^{PEI} \cdot {N}_{SG}^{PO} , where , {N}_{PO}^{PEI}$$

is the number of paging occasions configured by higher layer parameter po-NumPerPEI, and N_{SG}^{PO} is the number of sub-groups of a paging occasion configured by higher layer parameter subgroupsNumPerPO. Each bit in the field indicates one UE subgroup of a paging occasion. (2) TRS availability indication, which can be of size 1-6 bits, where the number of bits is equal to one plus the highest value of the indBitID(s) provided by the trs-ResourceSetConfig if configured; 0 bits otherwise. Each TRS resource set is configured with an ID i for the association with (i+1)-th indication bit.

Embodiments of the present disclosure recognize that early triggering of SRS initiated by a UE is needed. For example, this can be in response to arrival of UL data at the UE. The UE sends a trigger to the network for early SRS transmission. In one example, the trigger can be an UL wake up signal (UL WUS). Early SRS transmission can assist in determining the channel conditions and better link adaptation and better precoding for downlink and uplink transmissions. The triggering of early SRS can be for UEs in idle state, or inactive state, or in connected state. In this disclosure, design aspects related to the configuration and structure of the trigger signal (e.g., UL WUS) for early SRS are evaluated. Also, the content of the trigger signal for early SRS is evaluated. Also, the response of the UE and the network to the UE-initiated early SRS trigger is evaluated. Also, beam related aspects for the spatial domain filter of the early SRS trigger and the early SRS and any associated signals or channels are evaluated.

FIG. 10 illustrates a flowchart of an example procedure 1000 for triggering SRS transmission according to embodiments of the present disclosure. For example, procedure 1000 can be performed by any of the UEs 111-116 of FIG. 1. This example is for illustration only and other embodiments can be used without departing from the scope of the present disclosure.

The procedure begins in 1010, a UE is in IDLE or INACTIVE state. In 1020, data arrives to the at the UE. In 1030, the UE transitions to CONNECTED state. In 1040, data transmission can start. In 1050, the UE performs channel sounding with SRS. In 1060, there is a data transmission delay to use channel estimate.

When a UE is in RRC_IDLE state or RRC_INACTIVE state, and data arrives at the network for the UE, or data arrives at the UE for the network, the UE through RRC setup procedure or RRC reconfiguration procedure transitions to the RRC_CONNECTED state. After transition to the RRC_CONNECTED state the network can trigger SRS transmission from the UE for channel state or quality estimation and the UE can start transmitting and receiving data. This is illustrated in FIG. 10. The SRS trigger can be for wideband SRS or for sub-band SRS, which would require several SRS transmission instances to provide an estimate of the channel state or quality of the full bandwidth. This process, i.e., the estimation of the channel state or quality, can take tens of milliseconds, and even longer with sub-band SRS. Data transmission/reception can be delayed until the channel state or quality has been estimated using SRS, hence increasing latency. Alternatively, data transmission/reception can proceed in parallel with the SRS transmission and by the time the channel state or quality is estimated, the data (depending on the amount of data) has already or mostly been transmitted or received, hence rendering the channel state or quality estimation less useful while preceding transmissions/receptions from/to the UE are with reduced spectral efficiency due to the absence of a channel state or quality estimate at the gNB for the UE.

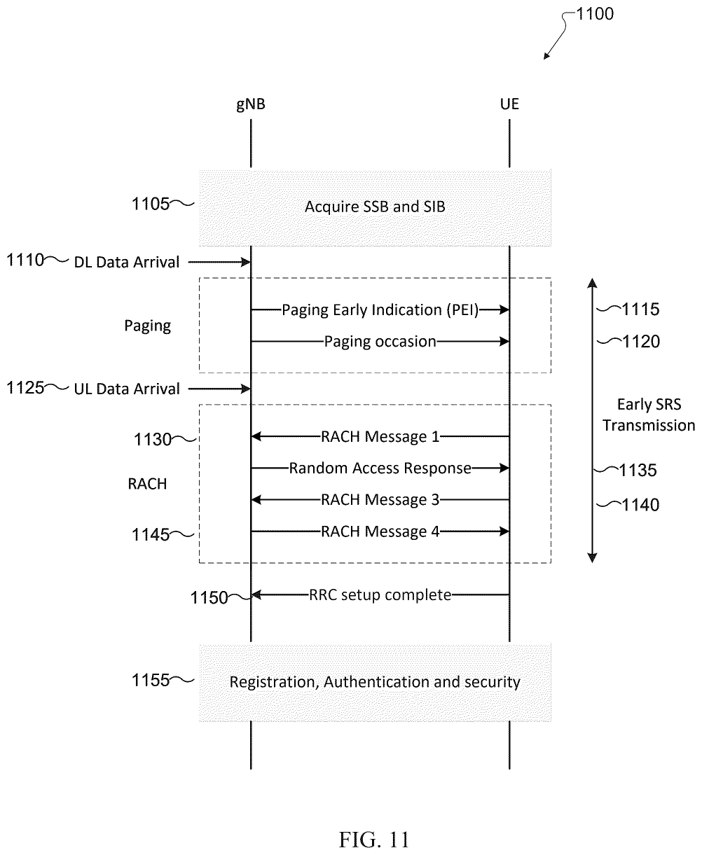

FIG. 11 illustrates a flowchart of an example procedure 1100 for RRC setup/configuration according to embodiments of the present disclosure. For example, procedure 1100 can be performed by the gNB 102 and/or network 130 in the wireless network 100 of FIG. 1, and/or the UE 116 in the wireless network 100 of FIG. 1. This example is for illustration only and other embodiments can be used without departing from the scope of the present disclosure.

The procedure begins in 1105, the UE acquires SSB and SIB. In 1110, DL data arrives at the gNB. In 1115, the gNB transmits a paging early indication (PEI) to the UE. In 1120, the gNB transmits a paging occasion to the UE. In 1125, UL data arrives to the UE. In 1130, the UE transmits RACH message 1 to the gNB, e.g., in response to paging from the gNB or in response to arrival of UL data. In 1135, the gNB transmits a random access response to the UE. In 1140, the UE transmits RACH message 3 to the gNB. In 1145, the gNB transmits the RACH message 4 to the UE. In 1150, the UE transmits a RRC setup complete (indication/message) to the gNB. In 1155, registration, authentication, and security are provided to/for/by the gNB and UE.

To mitigate this issue, it is beneficial to have the channel state or quality estimated in parallel with the RRC setup procedure, or RRC reconfiguration procedure such that when the UE is ready to transmit or receive data at the completion of the setup or reconfiguration procedures, the channel state or quality has already been estimated and link adaptation and precoding for uplink or downlink data is based on the estimated channel state or quality. Hence, there is a benefit for transmitting SRS in parallel with RRC setup procedure, or RRC reconfiguration procedure to reduce latency as illustrated in FIG. 11. Furthermore, the RRC setup messages can benefit from the channel state or quality estimation performed by early SRS. For example, in FIG. 11, if channel information from early SRS is known before the exchange of registration, authentication and security messages, the channel information can be leveraged for the transmission of these message, hence providing a more efficient message exchange.

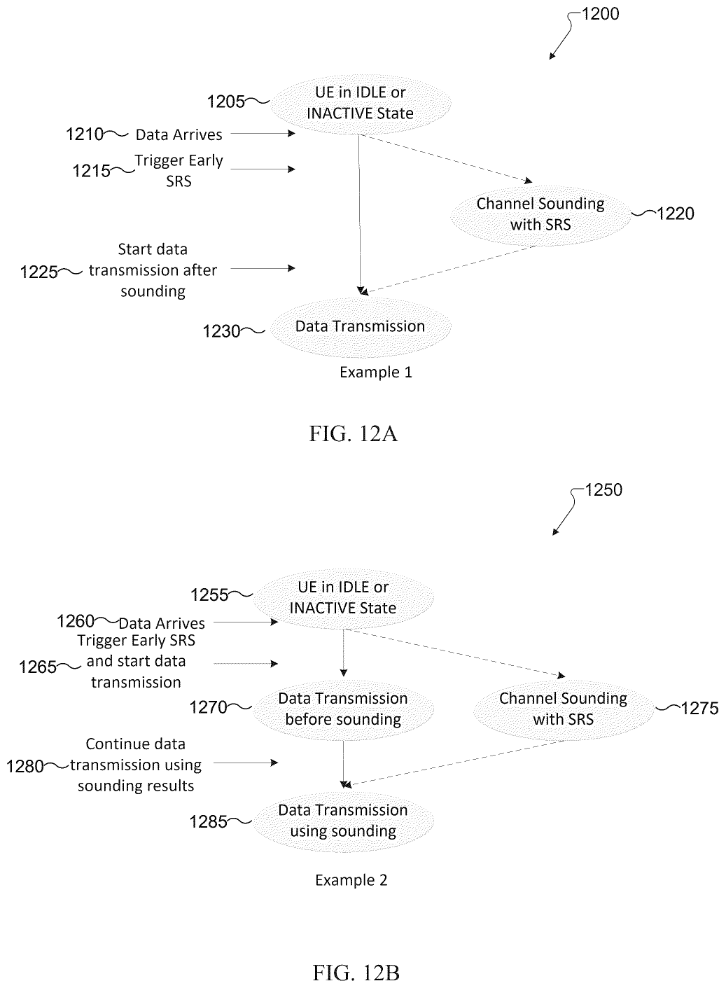

FIGS. 12A and 12B illustrate a flowcharts of example procedures 1200 and 1250 for triggering early SRS according to embodiments of the present disclosure. For example, procedures 1200 and 1250 can be performed by any of the UEs 111-116 of FIG. 1, such as the UE 112. This example is for illustration only and other embodiments can be used without departing from the scope of the present disclosure.

The procedure begins in 1205, a UE is in IDLE or INACTIVE state. In 1210, data arrives. In 1215, early SRS is triggered. In 1220, channel sounding with SRS is performed. In 1225, data transmission starts after sounding. In 1230, data is transmitted.

The procedure begins in 1255, a UE is in IDLE or INACTIVE state. In 1260, data arrives. In 1265, early SRS is triggered and data transmission starts. In 1270, data is transmitted before sounding. In 1275, channel sounding with SRS is performed. In 1280, data transmission continues using sounding results. In 1285, data is transmitted using sounding.

In variant examples of this disclosure, a UE in IDLE or INACTIVE states has data to transmit to the network, the UE transmits this data while in IDLE or INACTIVE states and doesn't transition to the CONNECTED mode. In this example, early SRS can be triggered before (Example 1 of FIG. 12) or during (Example 2 of FIG. 12) the data transmission. Data transmissions after the channel has been sounded by early SRS can leverage the channel state information for more efficient data transfer.

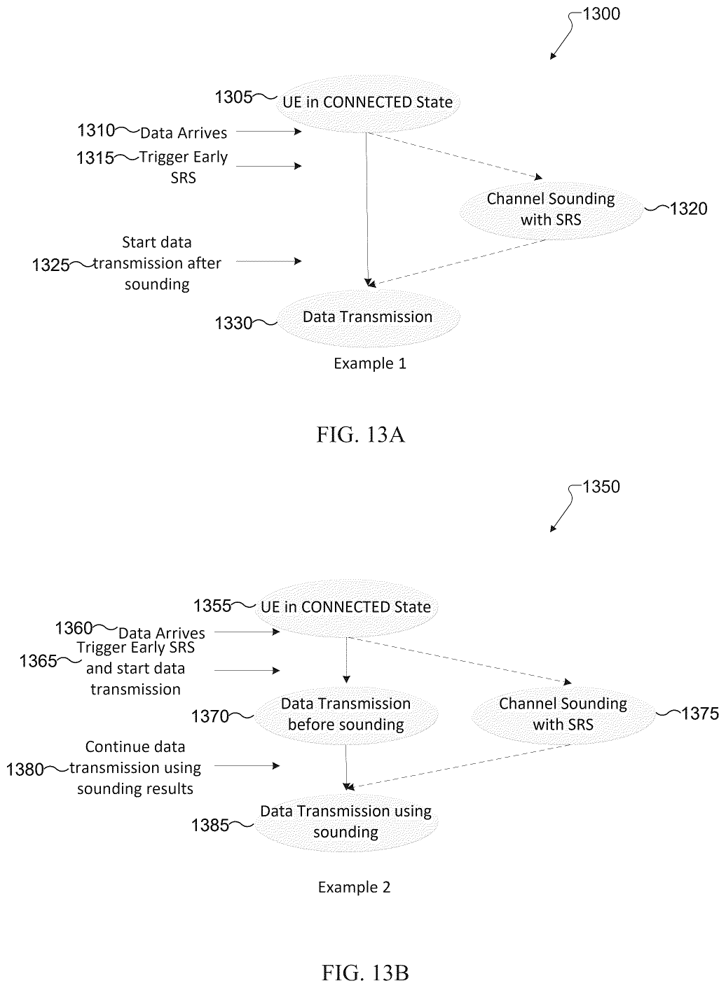

FIGS. 13A and 13B illustrate a flowcharts of example procedures 1300 and 1350 for triggering early SRS according to embodiments of the present disclosure. For example, procedures 1300 and 1350 can be performed by any of the UEs 111-116 of FIG. 1, such as the UE 113. This example is for illustration only and other embodiments can be used without departing from the scope of the present disclosure.

The procedure begins in 1305, a UE is in CONNECTED state. In 1310, data arrives. In 1315, early SRS is triggered. In 1320, channel sounding with SRS is performed. In 1325, data transmission starts after sounding. In 1330, data is transmitted.

The procedure begins in 1355, a UE is in CONNECTED state. In 1360, data arrives. In 1365, early SRS is triggered and data transmission starts. In 1370, data is transmitted before sounding. In 1375, channel sounding with SRS is performed. In 1380, data transmission is continued using sounding results. In 1385, data is transmitted using sounding.

In variant examples of this disclosure, a UE in CONNECTED state has data to transmit to the network. In these examples, early SRS can be triggered before (Example 1 of FIG. 13) or during (Example 2 of FIG. 13) the data transmission. Data transmissions after the channel has been sounded by early SRS can leverage the channel state information for more efficient data transfer.

In the examples of this disclosure, a UE (e.g., the UE 116) triggers or initiates early SRS transmission, by transmitting a signal to the network (e.g., the network 130). For example, this signal can be an uplink wake up signal (UL WUS) that is received by a low power radio (LR) at the gNB (e.g., the BS 102). In a variant example, this can be an uplink signal similar to physical uplink control channel (PUCCH) or physical random access control channel (PRACH) or physical uplink shared channel (PUSCH). In response to this signal SRS is transmitted. In one example, the SRS can be transmitted by UE in response to a signal transmitted from the gNB. In another example, the SRS can be transmitted autonomously by the UE.

The present disclosure relates to a 5G/NR and/or 6G communication system.

This disclosure evaluates aspects related to design of UE initiated early triggering of SRS. This disclosure includes the following:
Procedure aspects for UE triggering of early SRS.
Physical structure and configuration of the trigger signal.
Content of the trigger signal.
Configuration and indication of the early SRS resources
UE identification for early SRS.
Beam related aspects for the spatial domain filter of the early SRS trigger and the early SRS and any associated signals or channels.

In the following, both frequency division duplexing (FDD) and time division duplexing (TDD) are regarded as a duplex method for DL and UL signaling. In addition, full duplex (XDD) operation is possible, e.g., sub-band full duplex (SBFD) or single frequency full duplex (SFFD).

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure evaluates several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based signaling (e.g., SIB1 or other SIB) or (2) RRC dedicated signaling that is sent to a specific UE wherein the information can be common/cell-specific information or dedicated/UE-specific information or (3) UE-group RRC signaling.

In this disclosure MAC CE signaling can be UE-specific e.g., to one UE or can be UE common (e.g., to a group of UEs or all UEs in a cell). MAC CE signaling can be DL MAC CE signaling or UL MAC CE signaling.

In this disclosure L1 control signaling includes: (1) DL control information (e.g., DCI on PDCCH or DL control information on PDSCH) and/or (2) UL control information (e.g., UL control information (UCI) on PUCCH or PUSCH). L1 control signaling can be UE-specific e.g., to one UE or can be UE common (e.g., to a group of UEs or all UEs in a cell).

In this disclosure, configuration can refer to configuration by semi-static signaling (e.g., RRC or SIB signaling). In one example, a configuration can be applicable to multiple transmission instances, until a new configuration is received and applied.

In this disclosure, indication can refer to indication by dynamic signaling (e.g., L1 control (e.g., DCI Format) or MAC CE signaling). In one example, an indication can be for an associated occasion(s) (e.g., an occasion or multiple occasions associated with the indication).

In this disclosure a list with N elements can be denoted as L(i), where i can take N values, and L(i) can correspond to the element or entry associated with index i. In one example, i can take N arbitrary values. In one example, i=0, 1, . . . , N−1. In one example, i=1, 2, . . . , N. In one example, i is an identity of an element in the list.

In the present disclosure, the term “activation” describes an operation wherein a UE receives and decodes first information provided by a first signal from the network (or gNB) and, based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and, based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group of RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

Terminology such as TCI, TCI states, SpatialRelationInfo, target RS, reference RS, and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as non-zero power (NZP) CSI-RS and/or SSB) with the result of the measurement used for calculating a beam report (e.g., including at least one L1-RSRP/L1—signal-to-interference-plus-noise ratio (SINR) accompanied by at least one channel quality indicator (CQI) report interval (CRI) or SSB resource indicator (SSBRI)). As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the needed information to assign a particular DL (or/and UL) TX beam to the UE, for example in case of channel reciprocity.

In this disclosure, DCI Format is used for L1 control information in the DL direction from gNB to UE. DCI Format (i.e., L1 control information) can be single stage/part control information or two stage/part control information. In one example, the DCI format can be carried on a physical downlink control channel (PDCCH). In one example, DCI format can be carried on a physical downlink shared channel (PDSCH). In one example, DCI can be split between PDCCH (e.g., for a first part) and PDSCH (e.g. for a second part). In one example, DCI can be split between a first PDCCH (e.g., for a first part) and a second PDCCH (e.g. for a second part).

In this disclosure, a time unit can be a symbol or a slot or sub-frame or a frame. A time-unit can be multiple symbols, or multiple slots or multiple sub-frames or multiple frame. A time-unit can be a sub-slot (e.g., part of a slot).

In this disclosure, a higher layer message (e.g., SIB-based or RRC-based or MAC CE-based) can be carried by a physical downlink shared channel (PDSCH). In one example, the PDSCH can be scheduled by a DCI format.

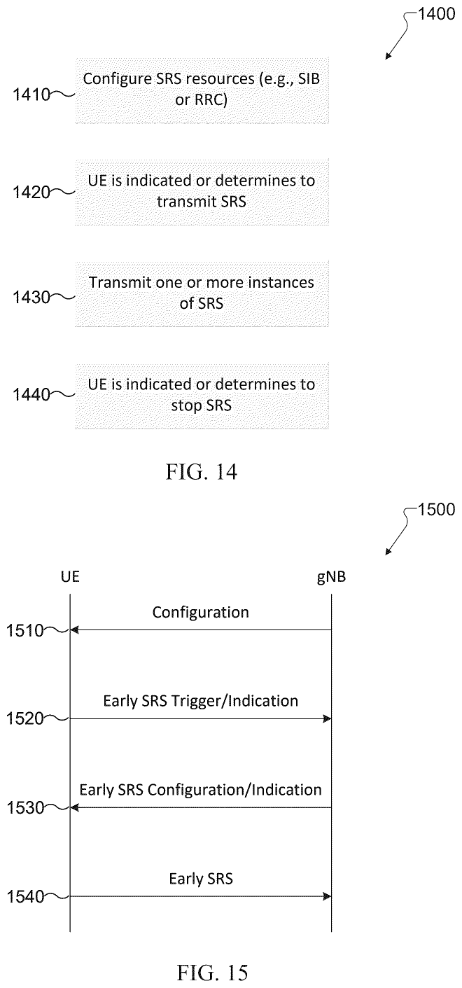

FIG. 14 illustrates a flowchart of an example procedure 1400 for transmitting SRS according to embodiments of the present disclosure. For example, procedure 1400 can be performed by any of the UEs 111-116 of FIG. 1, such as the UE 114. This example is for illustration only and other embodiments can be used without departing from the scope of the present disclosure.

The procedure begins in 1410, a UE is configured with SRS resources (e.g., system information block (SIB), e.g., SIB1 or other SIB, or RRC). In 1420, the UE is indicated or determines to transmit SRS. In 1430, the ULE transmits one or more instances of SRS. In 1440, the UE is indicated or determines to stop RS.

In one example, the configuration of early SRS resources can be configured or updated, by SIB signaling and/or RRC signaling and/or MAC CE signaling and/or L1 control signaling.

In one example, the configuration of the SRS resource can include:
SRS resource ID
Time and frequency resources (e.g., symbols within a slot for SRS, starting symbol for SRS, number of repetitions, time slot and/or subframe and/or frame for SRS, periodicity and offset of SRS (e.g., in case of periodic or semi-persistent SRS), starting PRB/sub-carrier/sub-channel (a sub-channel is a group of PRBs) for SRS, number of PRBs/sub-carriers/sub-channels for SRS, whether frequency hopping is enabled and if enabled frequency hopping pattern, etc.).
Number of instances, K, of SRS transmitted when SRS is triggered.
Comb size, comb offset and cycle shift.
Sequence for reference signal.
Spatial relation or TCI state information for SRS. Whether or not an SRS resource follows the unified or indicated TCI state. If TCI state (e.g., unified TCI state) includes more than one TCI state (e.g., more than one UL TCI state and/or more than joint TCI state), which of the more than one TCI states to apply.
Power for reference signal.

With reference to FIG. 14, an example of embodiments of this disclosure is shown. A UE can be configured with SRS resources and/or SRS resource sets by system information (e.g., SIB, e.g., SIB1 or other SIB) or by RRC configuration. The UE can be indicated or determines to transmit SRS. The UE, based on the indication or determination of SRS transmission, and the configured SRS resources, transmits SRS in one or more SRS transmission instances. In one example, the transmission is one-shot (e.g., one SRS transmission instance, or one SRS transmission instance per sub-band). In one example, the transmission is N-shot (e.g., N SRS transmission instances, or N SRS transmission instances per sub-band). In one example, the transmission is periodic. In one example, a UE can optionally determine or is indicated to stop SRS transmission (for example in case of periodic SRS transmission, or in case of N-shot SRS transmission).

FIG. 15 illustrates a flowchart of an example procedure 1500 for transmitting early SRS according to embodiments of the present disclosure. For example, procedure 1500 can be performed by any of the UEs 111-116 of FIG. 1, such as the UE 115, and the BS 102 of FIG. 1. This example is for illustration only and other embodiments can be used without departing from the scope of the present disclosure.

The procedure begins in 1510, a gNB transmits a configuration to a UE. In 1520, the UE transmits an early SRS trigger/indication to the gNB. In 1530, the gNB transmits an early SRS configuration/indication to the UE. In 1540, the UE transmits an early SRS to the gNB.

In one example as illustrated in FIG. 15, a UE is provided or configured with configuration information for early SRS. Configuration information can include resources or configurations to use for a signal or channel from the UE to the network to trigger or indicate early SRS. Configuration information can include resources or configurations to use for a signal or channel from the network to the UE to configure or indicate early SRS (e.g., feedback signal). Configuration information can include resources or configurations to use early SRS. A UE initiates the transmission of early SRS by sending a signal or a channel to the network (e.g., early SRS trigger or indication). In response the network transmits a DL channel or signal that can include an indication/configuration of an SRS configuration or SRS resources to be transmitted by the UE. In response to the DL channel or signal the UE transmits the early SRS. In one example, configuration information is provided from a same cell or gNB or TRP. In one example, configuration information is provided from different cells or gNBs or TRPs. For example, a first cell or gNB or TRP provides configuration information for a signal or channel from the UE to the network to trigger or indicate early SRS, a second cell or gNB or TRP provides configuration information for a signal or channel from the network to the UE to configure or indicate early SRS (e.g., feedback signal), and a third cell or gNB or TRP provides configuration information for early SRS. In one example, some or all of the first or second or third cells/gNBs/TRPs may be the same. In one example, the first and second and third cells/gNBs/TRPs may be different. In one example, a signal or channel from the UE to the network to trigger or indicate early SRS is transmitted towards a fourth cell. In one example, a signal or channel from the network to the UE to configure or indicate early SRS (e.g., feedback signal) is transmitted from a fifth cell. In one example, the early SRS is transmitted towards a sixth cell. In one example, some or all of the first or second or third or fourth or fifth or sixth cells/gNBs/TRPs may be the same. In one example, the first and second and third and fourth and fifth and sixth cells/gNBs/TRPs are/may be different. In one example, the first and fourth cells/gNBs/TRPs are the same. In one example, the second and fifth cells/gNBs/TRPs are the same. In one example, the third and sixth cells/gNBs/TRPs are the same. In one example, the fourth and sixth cells/gNBs/TRPs are the same. In one example, configuration information is from a cell/gNB/TRP (e.g., first, second and third cells/gNBs/TRPs are the same), and message exchange is to/from a different cell/gNB/TRP (e.g., fourth, fifth and sixth cells/gNBs/TRPs are the same but different from first, second and third cells/gNBs/TRPs).

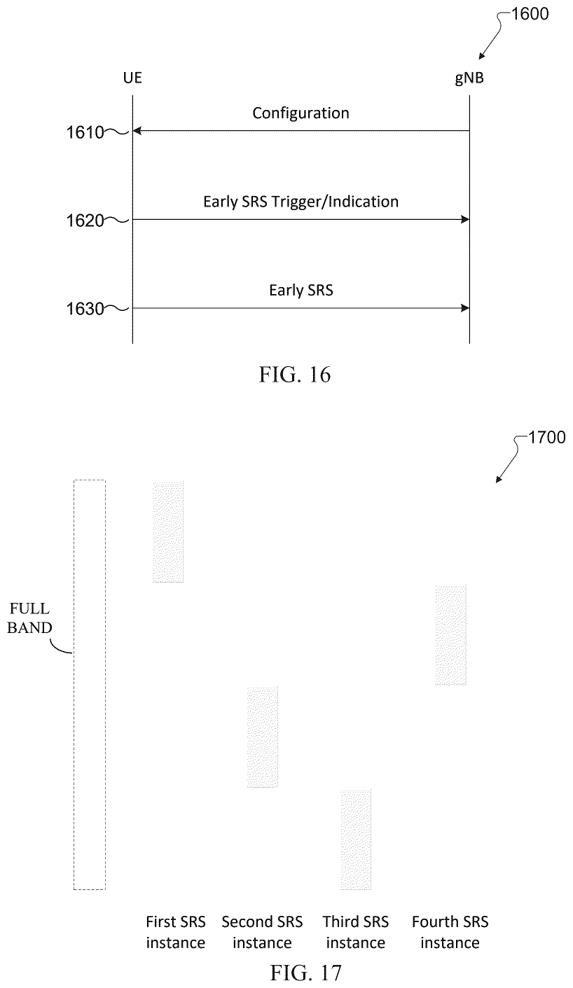

FIG. 16 illustrates a flowchart of an example procedure 1600 for transmitting early SRS according to embodiments of the present disclosure. For example, procedure 1600 can be performed by the UE 116 of FIG. 2 and the BS 102 of FIG. 1. This example is for illustration only and other embodiments can be used without departing from the scope of the present disclosure.

The procedure begins in 1610, a gNB transmits a configuration to a UE. In 1620, the UE transmits an early SRS trigger/indication to the gNB. In 1630, the UE transmits an early SRS to the gNB.

In one example as illustrated in FIG. 16, a UE is provided or configured with configuration information for early SRS. Configuration information can include resources or configurations to use for a signal or channel from the UE to the network to trigger or indicate early SRS. Configuration information can include resources or configurations to use early SRS. A UE initiates the transmission of early SRS by sending a signal or a channel to the network (e.g., early SRS trigger or indication). The UE then transmits the early SRS based on the signal or channel (e.g., early SRS trigger or indication). In one example, configuration information is provided from a same cell or gNB or TRP. In one example, configuration information is provided from different cells or gNBs or TRPs. For example, a first cell or gNB or TRP provides configuration information for a signal or channel from the UE to the network to trigger or indicate early SRS, and a second cell or gNB or TRP provides configuration information for early SRS. In one example, first and second cells/gNBs/TRPs are the same. In one example, the first and second cells/gNBs/TRPs may be different. In one example, the signal or channel from the UE to the network to trigger or indicate early SRS is transmitted towards a third cell. In one example, the early SRS is transmitted towards a fourth cell. In one example, some or all of the first or second or third or fourth cells/gNBs/TRPs may be the same. In one example, the first and second and third and fourth cells/gNBs/TRPs are/may be different. In one example, the first and third cells/gNBs/TRPs are the same. In one example, the second and fourth cells/gNBs/TRPs may be the same. In one example, the third and fourth cells/gNBs/TRPs are the same. In one example, configuration information is from a cell/gNB/TRP (e.g., first and second cells/gNBs/TRPs are the same), and message exchange is to a different cell/gNB/TRP (e.g., third and fourth cells/gNBs/TRPs are the same but different from first and second cells/gNBs/TRPs).

In one example, resources used for SRS transmission, can be one of a set or group of resources configured by the network, e.g., by system information (SIB, e.g., SIB1 or other SIB) or RRC configuration. The SRS resource ID, e.g., of an SRS resource, can be indicated or determined as described in this disclosure. In one example, when an SRS resource ID is indicated or determined, a subset of SRS resources is determined as described in this disclosure and a resource within the subset is indicated as described in this disclosure. In one example, when an SRS resource ID is indicated or determined, a subset of SRS resources is indicated as described in this disclosure and a resource within the subset is determined as described in this disclosure.

In one example, the configuration of the SRS resource parameters or a subset of the SRS resource parameters can be indicated to the UE.

In one example, the time (e.g., slot/symbols) of the SRS transmission (e.g., the start of the first instance of the SRS transmission) can be relative to the signal or channel from the network, e.g., the early SRS configuration/indication message of FIG. 15. In one example, the time (e.g., slot/symbols) of the SRS transmission (e.g., the start of the first instance of the SRS transmission) can be relative to the signal or channel from the UE, e.g., the early SRS trigger/indication message of FIG. 15. In one example, the time of the SRS transmission (e.g., relative to one of the signals mentioned herein or absolute time) can be included in the signal or channel from the network, e.g., the early SRS configuration/indication message of FIG. 15. In one example, the time of the SRS transmission (e.g., relative to one of the signals mentioned herein or absolute time) can be included in the signal or channel from the UE, e.g., the early SRS trigger/indication message of FIG. 15. In one example, the time of the SRS transmission (e.g., relative to one of the signals mentioned herein or absolute time) can be configured by higher layers, e.g., configured by SIB or configured by RRC.

In one example, the time (e.g., slot/symbols) of the SRS transmission (e.g., the start of the first instance of the SRS transmission) can be relative to the signal or channel from the UE, e.g., the early SRS trigger/indication message of FIG. 16. In one example, the time of the SRS transmission (e.g., relative to one of the signals mentioned herein or absolute time) can be included in the signal or channel from the UE, e.g., the early SRS trigger/indication message of FIG. 16. In one example, the time of the SRS transmission (e.g., relative to one of the signals mentioned herein or absolute time) can be configured by higher layers, e.g., configured by SIB or configured by RRC.

FIG. 17 illustrates example SRS transmission instances 1700 according to embodiments of the present disclosure. For example, SRS transmission instances 1700 can be transmitted by any of the UEs 111-1156 of FIG. 1, such as the UE 116. This example is for illustration only and other embodiments can be used without departing from the scope of the present disclosure.

In one example, an SRS transmission triggered as described in this disclosure can be one of.
A single instance SRS transmission. In one example, the single transmission instance is for the SRS resource. In one example, the single transmission instance is per sub-band of SRS.
K instances of SRS transmissions. Wherein, K can be defined in the system specifications and/or configured or updated by system information and/or SIB signaling and/or RRC signaling and/or MAC CE signaling and/or L1 control signaling. In one example, K can be indicated in the message triggering the SRS transmission (e.g., the signal or channel from the network, e.g., the early SRS configuration/indication message of FIG. 15, or the signal or channel from the UE, e.g., the early SRS trigger/indication message of FIG. 15 or FIG. 16). In one example, the K transmission instances are for the SRS resource (e.g., these can be over a wideband or multiple sub-bands). In one example, the K transmission instances are per sub-band of SRS (e.g., each sub-band of SRS is transmitted in K transmission instances). Optionally, the UE can be indicated or determines to early terminate SRS transmissions.
A periodical or semi-persistent transmission until a reconfiguration message or deactivation message is transmitted to the UE, e.g., to stop the SRS transmission.

In one example, SRS is sub-band SRS. The number of sub-bands within the full band is N. In one example, SRS is transmitted K times when triggered. In one example K=N, In one example, K>=N. In one example, a hopping pattern is used to sweep the SRS transmission in the different sub-bands, as illustrated in FIG. 17.

With reference to FIG. 17, an example is shown with 4 sub-bands in the full band (i.e., N=4). SRS is transmitted in 4 different SRS instances at different frequency locations to estimate the quality of the channel in the full band.

In one example, a UE is provided a configuration for a signal or a channel to transmit for triggering or indicating early SRS. In one example, the configuration is provided in a SIB. In one example, the configuration is provided using RRC signaling. In one example, the configuration provided in SIB is used for users in IDLE state. In one example, the configuration provided in SIB is used for users in INACTIVE state. In one example, the configuration provided in SIB is used for users in CONNECTED state. In one example, the configuration provided by RRC is used for users in CONNECTED state. In one example, the configuration provided by RRC configuration is a subset of the configuration provided in SIB. In one example, the configuration provided by RRC configuration is orthogonal (different from) to the configuration provided in SIB. In one example, the configuration provided by RRC configuration is a superset of the configuration provided in SIB. In one example, for a UE in CONNECTED state, if provided RRC configuration, the configuration provided by SIB, if any, is not used. In one example, for a UE in CONNECTED state, if provided RRC configuration, the configuration provided by SIB, if any, is used in addition to the configuration provided by RRC. In one example, for a UE in CONNECTED state, if provided RRC configuration, the UE is indicated (e.g., in the RRC configuration or by other signaling) whether or not to use the configuration provided by SIB, if any.

In one example, multiple configurations for the signal or channel to trigger or indicate early SRS are provided, and the UE selects a configuration for transmission of signal or channel to trigger or indicate early SRS. In one example, a UE randomly selects or determines a configuration from the multiple configurations to transmit signal or channel to trigger or indicate early SRS. In one example, a UE selects a configuration from the multiple configurations, based on an ID associated with the UE, to transmit a signal or channel to trigger or indicate early SRS. In one example, the ID is based on 5G S-Temporary Mobile Subscription Identifier (5G-S-TMSI). In one example, the ID is based on I-RNTI. In one example, the ID is based on radio network temporary identifier (RNTI) (e.g., C-RNTI, or TC-RNTI). In one example, the ID is allocated or assigned by the network to the UE.

In one example, there are multiple (e.g., N) configuration for the signal or channel, from UE to network, to trigger or indicate the early SRS, each configuration has a configuration ID n, where n=0, 1, . . . , N−1. The UE selects a configuration ID based on an ID associated with the UE based on a rule or mapping between the ID associated with the UE and the configuration ID. In one example, the rule or mapping is given by: configuration ID=(ID associated with the UE) % N, where % is the modulo operator. In one example, the UE is provided, e.g., by higher layers, the configuration ID to use.

In one example a single configuration for the signal or channel to trigger or indicate early SRS is provided, and the UE uses such configuration to transmit signal or channel to trigger or indicate early SRS.

In one example, a configuration for a signal or channel to trigger or indicate early SRS is unique for each UE. In one example, a configuration for a signal or channel to trigger or indicate early SRS is shared by multiple UEs, a collision can occur if more than one UE selects the same configuration to transmit a signal or channel to indicate early SRS.

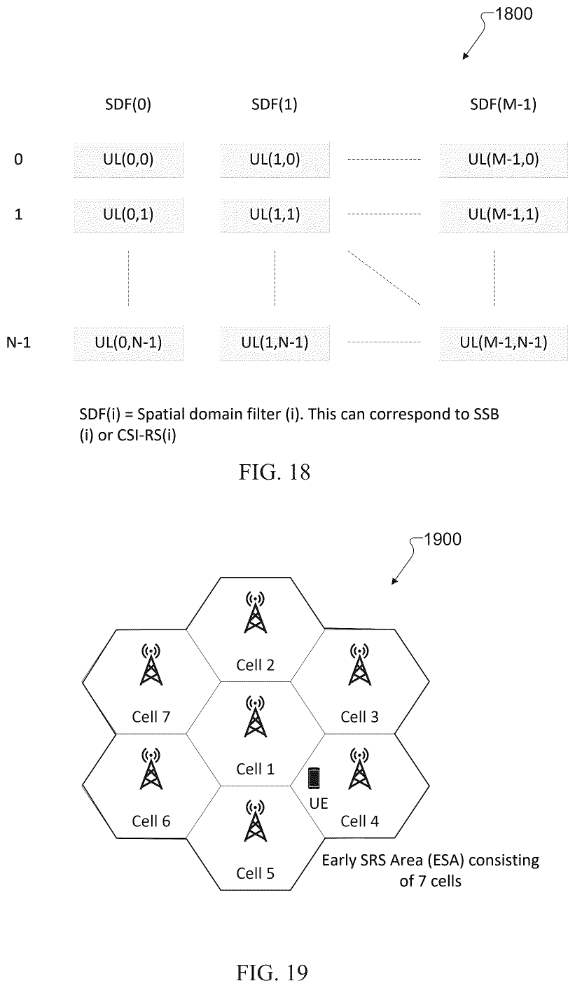

FIG. 18 illustrates an example spatial filter 1800 according to embodiments of the present disclosure. For example, spatial filter 1800 can be determined by any of the UEs 111-116 of FIG. 1, such as the UE 111. This example is for illustration only and other embodiments can be used without departing from the scope of the present disclosure.

In one example, the UE determines spatial filter for transmission of the signal or channel, from UE to network, to trigger or indicate the early SRS. In one example, the determination of the spatial filter is based on UEs implementation. In one example, the UE can transmit multiple signals or channels to trigger or indicate the early SRS using multiple spatial domain filters (e.g., beam sweeping). In one example, resources used for the signals or channels to trigger or indicate the early SRS using multiple spatial domain filters are linked, wherein the linking can be configured by SIB configuration or RRC configuration. In one example, the signals or channels to trigger or indicate the early SRS using multiple spatial domain filters include a parameter signaling or indicating that these are part of a same beam sweep. In one example, the signals or channels to trigger or indicate the early SRS using multiple spatial domain filters are time division multiplexed (e.g., transmitted in different time instances). In one example, the signals or channels to trigger or indicate the early SRS using multiple spatial domain filters are frequency division multiplexed (e.g., transmitted in different frequency resource).

In one example, the determination of the spatial filter for transmission of the signal or channel, from UE to network, to trigger or indicate the early SRS is based on measurements on DL signals. For example, the DL signals can be SSB (Synchronization Signal/Physical Broadcast Channel (PBCH) Block—SS/PBCH Block) or CSI-RS (Channel State Information Reference Signal). In one example, a UE determines an SSB, e.g., SSB with RSRP above a configured threshold or SSB with the largest RSRP), and the UE determines a spatial filter based on the SSB (e.g., based on beam correspondence between DL and UL). In one example, a UE determines a CSI-RS, e.g., CSI-RS with RSRP above a configured threshold or CSI-RS with the largest RSRP), and the UE determines a spatial filter based on the CSI-RS (e.g., based on beam correspondence between DL and UL).

In one example, a UE is configured a linkage between the signal or channel, from UE to network, to trigger or indicate the early SRS and a spatial domain filter. The UE selects or determines a signal or channel, from UE to network, to trigger or indicate the early SRS associated with (or based on) the selected spatial domain filter.

In one example, a UE (e.g., the UE 116) is configured a linkage between the signal or channel, from UE to network (e.g., the network 130), to trigger or indicate the early SRS and a reference signal (e.g., SSB or CSI-RS). The UE selects or determines a signal or channel, from UE to network, to trigger or indicate the early SRS associated with (or based on) the selected reference signal (e.g., SSB or CSI-RS). In one example, the linkage or association of the signal or channel, from UE to network, to trigger or indicate the early SRS and a reference signal (e.g., SSB or CSI-RS) can be by including or associating a reference signal ID (e.g., SSB ID or CSI-RS ID) in or with the configuration of the signal or channel to trigger or indicate the early SRS as described later in this disclosure.

In one example, there are multiple (e.g., L) resources or configurations for the signal or channel, from UE to network, to trigger or indicate the early SRS. A first subset of the configurations (e.g., of size N₀ resources or configurations) is associated with a first spatial domain filter or a first reference signal (e.g., first SSB (SSB(0)) or a first CSI-RS (CSI-RS(0)). A second subset of the resources or configurations (e.g., of size N₁ configurations) is associated with a second spatial domain filter or a second reference signal (e.g., second SSB (SSB(1)) or a second CSI-RS (CSI-RS(1)) . . . . A Mth subset of the resources or configurations (e.g., of size N_{M-1} configurations) is associated with a Mth spatial domain filter or a Mth reference signal (e.g., Mth SSB (SSB(M−1)) or a Mth CSI-RS (CSI-RS(M−1)).

In one example, the resources or configurations are can expressed as R(i,j), where i=0, 1, . . . , M−1, and j=0, 1, . . . , Nᵢ−1. Wherein, i can indicate a spatial domain filter i or reference signal i (e.g., SSB(i) or CSI-RS (i)) and j a resource or configuration within the Nᵢ resources or configurations associated with spatial domain filter i or reference signal i (e.g., SSB(i) or CSI-RS (i)). In one example, a UE determines or selects a spatial domain filter i or reference signal i (e.g., SSB(i) or CSI-RS (i)), the UE selects or determines a resource or configuration from the Nᵢ resources or configurations associated with spatial domain filter i or reference signal i (e.g., SSB(i) or CSI-RS (i)). In one example, the selection or determination of a resource or configuration from the Nᵢ resources or configurations can be based on UE's implementation. In one example, the selection or determination of a resource or configuration from the Nᵢ resources or configurations can be based on random selection. In one example, the selection or determination of a resource or configuration from the Nᵢ resources or configurations can be based on the UE's ID, wherein the UE ID is as mentioned herein. In one example, the selection or determination of a resource or configuration from the Nᵢ resources or configurations can be based on a rule e.g., configuration or resource ID within the Nᵢ resources or configurations=(ID associated with the UE) % N, where % is the modulo operator. In one example, Nᵢ=1, the UE uses the resource or configuration associated with spatial domain filter i or reference signal i (e.g., SSB(i) or CSI-RS (i)).

In one example, Nᵢ=N for i=0, 1, . . . M−1. This can be for example as illustrated in FIG. 18.

In one example, the signal or channel to trigger or indicate early SRS is an uplink wake-up signal (UL WUS). The UL WUS is received by a low power radio (low power receiver) in the gNB (e.g., the BS 102). In one example, UL WUS is OOK-1 (on off keying type 1) as described in TR 38.869. In one example, UL WUS is OOK-2 [TR 38.869]. In one example, UL WUS is OOK-3 [TR 38.869]. In one example, UL WUS is OOK-4 [TR 38.869]. In one example, the configuration of the UL-WUS includes one or more of the following parameters:
Time domain resources, including symbols (e.g., OFDM symbols) within a slot or sub-frame or frame to transmit UL-WUS, including one or more of the number of symbols, the starting symbol and/or the ending symbol.
Time domain resources including periodicity and offset within the periodicity, wherein the periodicity and/or offset within a periodicity can be in time-units, where time-units is as described herein in this disclosure.
In one example, time domain resources can include an offset (e.g., in time-units) from a corresponding reference signal (e.g., SSB or CSI-RS as described in the following).
Frequency domain resources including sub-carriers and/or PRBs and/or sub-channels (a sub-channel is a group or number of PRBs) and/or interlaces for transmission of UL-WUS. Frequency domain resources can include one or more of number of resources, starting resource and/or ending resource.
Comb size and comb offset if a comb structure is used for the frequency resources. For example, a comb of size M, transmits every Mth frequency resource starting from an offset (comb offset).
ID of code or sequence. For example, this can be an overlaid sequence on the UL-WUS.
UL-WUS configuration index, wherein the UL-WUS configuration index points to a UL-WUS configuration in a set or list of configured UL-WUS resources.
A spatial domain transmission filter. In one example, the spatial domain transmission filter corresponds to an SSB (Synchronization Signal/Physical Broadcast Channel (PBCH) Block—SS/PBCH Block). A UE determines an SSB, e.g., SSB with RSRP (or SINR or reference signal received quality (RSRQ)) above a configured threshold or SSB with the largest RSRP (or SINR or RSRQ)), and selects or determines a resource for the UL-WUS associated with the determined SSB. In one example, the spatial domain transmission filter corresponds to an CSI-RS (Channel State Information Reference Signal), e.g., CSI-RS ID. A UE determines a CSI-RS, e.g., CSI-RS with RSRP (or SINR or RSRQ) above a configured threshold or CSI-RS with the largest RSRP (or SINR or RSRQ)), and selects or determines a resource for the UL-WUS associated the determined CSI-RS. In one example, the selection of the spatial domain filter is up to UE's implementation.

In one example, a set of resources is configured for UL-WUS, and the UE selects or determines a resource from the set of resources as mentioned herein. In one example, some of the parameters mentioned herein are common across the set of resources (e.g., periodicity), and can be configured for the set. In one example, some of the parameters mentioned herein are unique for a resource and are configured for that resource.

In one example, the signal or channel to trigger or indicate early SRS is a physical random access channel (PRACH). In one example, the configuration of the PRACH includes one or more of the following parameters:
Time domain resources, including symbols (e.g., OFDM symbols) within a slot or sub-frame or frame to transmit PRACH, including one or more of the number of symbols, the starting symbol and/or the ending symbol.
Time domain resources including PRACH occasions.
Time domain resources including periodicity and offset within the periodicity, wherein the periodicity and/or offset within a periodicity can be in time-units, where time-units is as described herein in this disclosure.
In one example, time domain resources can include an offset (e.g., in time-units) from a corresponding reference signal (e.g., SSB or CSI-RS as described in the following).
Frequency domain resources including sub-carriers and/or PRBs and/or sub-channels (a sub-channel is a group of PRBs) and/or interlaces for transmission of PRACH. Frequency domain resources can include one or more of number of resources, starting resource and/or ending resource.
Root sequence and/or cyclic shift.
PRACH configuration index.
Preamble format.
A spatial domain transmission filter. In one example, the spatial domain transmission filter corresponds to an SSB (Synchronization Signal/Physical Broadcast Channel (PBCH) Block—SS/PBCH Block). A UE determines an SSB, e.g., SSB with RSRP (or SINR or RSRQ) above a configured threshold or SSB with the largest RSRP (or SINR or RSRQ)), and selects or determines a resource for the PRACH associated with the determined SSB. In one example, the spatial domain transmission filter corresponds to an CSI-RS (Channel State Information Reference Signal), e.g., CSI-RS ID. A UE determines a CSI-RS, e.g., CSI-RS with RSRP (or SINR or RSRQ) above a configured threshold or CSI-RS with the largest RSRP (or SINR or RSRQ)), and selects or determines a resource for the PRACH associated with the determined CSI-RS. In one example, the selection of the spatial domain filter is up to UE's implementation.

In one example, a set of resources is configured for PRACH, and the UE selects or determines a resource from the set of resources as mentioned herein. In one example, some of the parameters mentioned herein are common across the set of resources (e.g., periodicity), and can be configured for the set. In one example, some of the parameters mentioned herein are unique for a resource and are configured for that resource.

In one example, the signal or channel to trigger or indicate early SRS is a physical uplink control channel (PUCCH). In one example, the configuration of the PUCCH includes one or more of the following parameters:
Time domain resources, including symbols (e.g., OFDM symbols) within a slot or sub-frame or frame to transmit PUCCH, including one or more of the number of symbols, the starting symbol and/or the ending symbol.
Time domain resources including periodicity and offset within the periodicity, wherein the periodicity and/or offset within a periodicity can be in time-units, where time-units is as described herein in this disclosure.
In one example, time domain resources can include an offset (e.g., in time-units) from a corresponding reference signal (e.g., SSB or CSI-RS as described in the following).
Frequency domain resources including sub-carriers and/or PRBs and/or sub-channels (a sub-channel is a group of PRBs) and/or interlaces for transmission of PUCCH. Frequency domain resources can include one or more of number of resources, starting resource and/or ending resource.
ID of code or sequence for PUCCH.
Cyclic shift for PUCCH.
PUCCH configuration index, wherein the PUCCH configuration index points to a PUCCH configuration in a set or list of configured PUCCH resources.
PUCCH format (e.g., PUCCH Format 0 or PUCCH Format 1 or PUCCH Format 2 or PUCCH Format 3 or PUCCH Format 4).
A spatial domain transmission filter. In one example, the spatial domain transmission filter corresponds to an SSB (Synchronization Signal/Physical Broadcast Channel (PBCH) Block—SS/PBCH Block). A UE determines an SSB, e.g., SSB with RSRP (or SINR or RSRQ) above a configured threshold or SSB with the largest RSRP (or SINR or RSRQ)), and selects or determines a resource for the PUCCH associated with the determined SSB. In one example, the spatial domain transmission filter corresponds to an CSI-RS (Channel State Information Reference Signal), e.g., CSI-RS ID. A UE determines a CSI-RS, e.g., CSI-RS with RSRP (or SINR or RSRQ) above a configured threshold or CSI-RS with the largest RSRP (or SINR or RSRQ)), and selects or determines a resource for the PUCCH associated with the determined CSI-RS. In one example, the selection of the spatial domain filter is up to UE's implementation.

In one example, a set of resources is configured for PUCCH, and the UE selects or determines a resource from the set of resources as mentioned herein. In one example, some of the parameters mentioned herein are common across the set of resources (e.g., periodicity), and can be configured for the set. In one example, some of the parameters mentioned herein are unique for a resource and are configured for that resource.

In one example, the signal or channel to trigger or indicate early SRS is a physical uplink shared channel (PUSCH). In one example, the configuration of the PUSCH includes one or more of the following parameters:
Time domain resources, including symbols (e.g., OFDM symbols) within a slot or sub-frame or frame to transmit PUSCH, including one or more of the number of symbols, the starting symbol and/or the ending symbol.
Time domain resources including periodicity and offset within the periodicity, wherein the periodicity and/or offset within a periodicity can be in time-units, where time-units is as described herein in this disclosure.
In one example, time domain resources can include an offset (e.g., in time-units) from a corresponding reference signal (e.g., SSB or CSI-RS as described in the following).
Frequency domain resources including sub-carriers and/or PRBs and/or sub-channels (a sub-channel is a group of PRBs) and/or interlaces for transmission of PUSCH. Frequency domain resources can include one or more of number of resources, starting resource and/or ending resource.
ID of code or sequence for PUSCH.
PUSCH configuration index, wherein the PUSCH configuration index points to a PUSCH configuration in a set or list of configured PUSCH resources.
A spatial domain transmission filter. In one example, the spatial domain transmission filter corresponds to an SSB (Synchronization Signal/Physical Broadcast Channel (PBCH) Block—SS/PBCH Block). A UE determines an SSB, e.g., SSB with RSRP (or SINR or RSRQ) above a configured threshold or SSB with the largest RSRP (or SINR or RSRQ)), and selects or determines a resource for the PUSCH associated with the determined SSB. In one example, the spatial domain transmission filter corresponds to an CSI-RS (Channel State Information Reference Signal), e.g., CSI-RS ID. A UE determines a CSI-RS, e.g., CSI-RS with RSRP (or SINR or RSRQ) above a configured threshold or CSI-RS with the largest RSRP (or SINR or RSRQ)), and selects or determines a resource for the PUSCH associated with the determined CSI-RS. In one example, the selection of the spatial domain filter is up to UE's implementation.

In one example, a set of resources is configured for PUSCH, and the UE selects or determines a resource from the set of resources as mentioned herein. In one example, some of the parameters mentioned herein are common across the set of resources (e.g., periodicity), and can be configured for the set. In one example, some of the parameters mentioned herein are unique for a resource and are configured for that resource.

In one example, the signal or channel, from the UE to the network to trigger or indicate early SRS can include or indicate the UE ID or part of the UE ID. The UE ID can be as mentioned herein. In one example, the indication can be based on the resource/configuration (or resource/configuration ID) used for the signal or channel to trigger the early SRS. In one example, part of the UE ID can be included in the signal or channel to trigger the early SRS and part can be indicated based on the resource/configuration (or resource/configuration ID) used for the signal or channel to trigger the early SRS.

In one example, the signal or channel, from the UE to the network to trigger or indicate early SRS can include or indicate the spatial domain filter or reference signal (e.g., SSB or CSI-RS) selected by the UE. The spatial domain filter or reference signal (e.g., SSB or CSI-RS) selected by the UE can be as mentioned herein. In one example, the indication can be based on the resource/configuration (or resource/configuration ID) used for the signal or channel to trigger the early SRS. In one example, part of the spatial domain filter or reference signal (e.g., SSB or CSI-RS) selected by the UE can be included in the signal or channel to trigger the early SRS and part can be indicated based on the resource/configuration (or resource/configuration ID) used for the signal or channel to trigger the early SRS.

In one example, the signal or channel from the network for early SRS configuration or indication can be included in a downlink control information (DCI) Format.

In one example, the signal or channel from the network for early SRS configuration or indication can be included in a medium access control—control element (MAC CE).

In one example, the signal or channel from the network for early SRS configuration or indication can be included in a radio resource control message.

In one example, the network can configure (e.g., using SIB signaling or RRC signaling) multiple (e.g., N) SRS configurations, the network indicates using dynamically signaling (e.g., using the signal or channel from the network for early SRS configuration or indication) one or a subset of these configurations.

In one example, the UE is configured or provided with multiple early SRS resources or configurations using higher layer signaling (e.g., SIB signaling or RRC signaling). In one example, each resource/configuration is associated with a resource/configuration ID. A UE is provided with a resource/configuration (or resource/configuration ID) for early SRS using the signal or channel from the network for early SRS configuration or indication. The provision can be by inclusion as part of the content or based on indication (e.g., based on the resource used or other parameters) of the signal or channel from the network for early SRS configuration or indication.

In one example, the UE is configured or provided with multiple early SRS resources or configurations using higher layer signaling (e.g., SIB signaling or RRC signaling). In one example, the resources or configurations can be further arranged into groups or subsets. In one example, each group or subset is associated with an ID. A UE is provided with a group/subset ID for early SRS using the signal or channel from the network for early SRS configuration or indication. The provision can be by inclusion as part of the content or based on indication (e.g., based on the resource used or other parameters) of the signal or channel from the network for early SRS configuration or indication. The UE selects or determines the resource or configuration for early SRS based on the group/subset ID and UEs determination or selection of resource/configuration within the group/subset as described later in this disclosure.

In one example, the signal or channel from the network for early SRS configuration or indication can include an availability indicator for part or all of SRS resources in a certain time period. For example, a SIB can configure a pool, which could be common for UEs in the cell for idle, inactive and connected UE, and dynamic signaling (e.g., signal or channel from the network for early SRS configuration or indication) can indicate part of them available or unavailable in the coming period for idle UEs only.

In one example, the signal or channel from the network for early SRS configuration or indication can be included or indicate parameters for early SRS resource such as:
Time domain resources:
   Aperiodic SRS: Slot and symbols used to transmit SRS, e.g., a slot or symbol offset from DCI triggering SRS. Starting or ending SRS symbol in slot. Number of SRS symbols in slots or subframes or frames. If N SRS instances are transmitted,
      offset between each instance and triggering DCI or
      offset between each instance and first SRS instance, or
      offset between each instance and previous instance.
   Periodic/semi-persistent SRS
      Period and offset
      Starting or ending SRS symbol in slot/subframe/frame.
      Number of SRS symbols in slots/subframes/frames.
Frequency domain
   Starting/ending sub-carrier or PRB or sub-channel
   Number of sub-carriers or PRBs or sub-channels
Comb information
   Comb size
   Comb offset
SRS sequence
Beam indication (e.g., SSB or CSI-RS) for spatial domain filter to use for SRS transmission.

In one example, the parameters herein can be configured (e.g., using SIB signaling or RRC signaling) and/or dynamically indicated, e.g., using MAC CE signaling or L1 control signaling (e.g., using signal or channel from the network for early SRS configuration or indication). A value that is semi-statically configured is used unless the value is updated by dynamic indication. Dynamically indicated values can be from a range of values that are specified in the specification or configured by SIB signaling or RRC signaling.

In one example, in case of periodic/semi-persistent SRS, dynamic signaling (e.g., using L1 control (e.g., DCI) or MAC CE) can de-activate early SRS.

In one example, multiple configurations for early SRS are provided (e.g., by SIB signaling and/or RRC signaling). A UE is further provided one of these configurations (e.g., based on a ID of a configuration from the multiple configurations) by a signal or channel from the network, e.g., the early SRS configuration/indication message of FIG. 15, the UE uses such configuration to transmit early SRS.

Example of two-stage determination of early SRS configuration (or resource), where first stage is performed by the network (to select a group or subset of configurations) and second stage is performed by the UE to select a configuration from the subset of configurations. In one example, multiple configurations for early SRS are provided (e.g., by SIB signaling and/or RRC signaling). A UE is further provided a subset of these configurations (e.g., based on a ID of a subset of the configurations from the multiple configurations or based on multiple configuration IDs) by a signal or channel from the network, e.g., the early SRS configuration/indication message of FIG. 15, the UE uses such configuration to transmit early SRS. The UE further selects one configuration from the subset of configurations to determine a configuration for the UE to use to transmit the early SRS. The selection by the UE of a configuration from the subset of configuration can be:
By random selection
Based on a rule, e.g., based on a UE ID as mentioned herein.

In one example, the UE uses a same spatial domain transmission filter for the signal or channel, from the UE to the network, to trigger or indicate early SRS and the signal used for early SRS.

In one example, the network (e.g., the network 130) can indicate to the UE the spatial domain transmission filter to use for early SRS. In one example, the indication can be by dynamic signaling (e.g., MAC CE signaling or L1 control (e.g., DCI) signaling or RRC signaling). In one example, the indication can be in the signal or channel from the network for early SRS configuration or indication.

In one example, the UE can be indicated a reference signal (RS) (e.g., RS ID) to use for determining the spatial domain filter. In one example, the RS can be SSB or CSI-RS or tracking reference signal (TRS).

In one example, the UE can be indicated a transmission configuration indicator (TCI) state to use for determining the spatial domain filter. In one example, the TCI state can be an UL TCI state or a Joint TCI state.

A time unit for DL signaling, for UL signaling, or for sidelink (SL) signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, or full UL slot, or hybrid slot similar to a special subframe in time division duplex (TDD) systems (see also REF 1). In addition, a slot can have symbols for SL communications. A UE can be configured one or more bandwidth parts (BWPs) of a system BW for transmissions or receptions of signals or channels.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format. A DCI format scheduling PDSCH reception or PUSCH transmission for a single UE, such as a DCI format with CRC scrambled by C-RNTI/configured scheduling RNTI (CS-RNTI)/modulation and coding scheme (MCS)-C-RNTI as described in [REF 2], are referred for brevity as a unicast DCI format. A DCI format scheduling PDSCH reception for multicast communication, such as a DCI format with CRC scrambled by group RNTI (G-RNTI)/group configured scheduling (G-CS)-RNTI as described in [REF 2], are referred to as multicast DCI format. DCI formats providing various control information to at least a subset of UEs in a serving cell, such as DCI format 20 in [REF 2], are referred to as group-common (GC) DCI formats.

A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB (such as BS 102) transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources. A UE (such as UE 116) can determine CSI-RS transmission parameters through DL control signaling or higher layer signaling, such as radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, link recovery request (LRR) for beam failure recovery, UE initiated report indication (UEIRI) and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB (e.g., the BS 102) can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH).

An antenna port is defined such that the channel over which a symbol on the antenna port is conveyed can be inferred from the channel over which another symbol on the same antenna port is conveyed.

For demodulation reference signal (DM-RS) associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may expect the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may expect that synchronization signal (SS)/PBCH block (also denoted as SSBs) transmitted with the same block index on the same center frequency location are quasi co-located with respect to Doppler spread, Doppler shift, average gain, average delay, delay spread, and, when applicable, spatial Rx parameters. The UE may not expect quasi co-location for any other synchronization signal SS/PBCH block transmissions.

In absence of CSI-RS configuration, and unless otherwise configured, the UE may expect PDSCH DM-RS and SSB to be quasi co-located with respect to Doppler shift, Doppler spread, average delay, delay spread, and, when applicable, spatial Rx parameters. The UE may expect that the PDSCH DM-RS within the same code division multiplexing (CDM) group is quasi co-located with respect to Doppler shift, Doppler spread, average delay, delay spread, and spatial Rx. The UE may also expect that DM-RS ports associated with a PDSCH are QCL with QCL type A, type D (when applicable) and average gain. The UE may further expect that no DM-RS collides with the SS/PBCH block.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi-co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi-co-location types corresponding to each DL RS are given by the higher layer parameter qcl-Type in QCL-Info and may take one of the following values: QCL-TypeA: {Doppler shift, Doppler spread, average delay, delay spread}; QCL-TypeB: {Doppler shift, Doppler spread}; QCL-TypeC: {Doppler shift, average delay}; and QCL-TypeD: {Spatial Rx parameter}.

The UE receives a MAC-control element (CE) activation command to map up to [N](e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot

$$( n + 3 {N}_{slot}^{subframe , μ} ) .$$

In this disclosure, a beam can be determined by any of:
A TCI state, that establishes a quasi-colocation (QCL) relationship or spatial relation between a source reference signal (e.g. SSB and/or CSI-RS) and a target reference signal
A spatial relation information that establishes an association to a source reference signal, such as SSB or CSI-RS or SRS.

In either case, the ID of the source reference signal or TCI state or spatial relation identifies the beam.

The TCI state and/or the spatial relation reference RS can determine a spatial Rx filter for reception of downlink channels at the UE, or a spatial Tx filter for transmission of uplink channels from the UE. The TCI state and/or the spatial relation reference RS can determine a spatial Tx filter for transmission of downlink channels from the gNB, or a spatial Rx filter for reception of uplink channels at the gNB.

Rel-17 introduced the unified TCI framework, where a unified or master or main or indicated TCI state is signaled to the UE. The unified or master or main or indicated TCI state can be one of: In case of joint TCI state indication, wherein a same beam is used for DL and UL channels, a joint TCI state that can be used at least for UE-dedicated DL channels and UE-dedicated UL channels; In case of separate TCI state indication, wherein different beams are used for DL and UL channels, a DL TCI state that can be used at least for UE-dedicated DL channels; and/or in case of separate TCI state indication, wherein different beams are used for DL and UL channels, a UL TCI state that can be used at least for UE-dedicated UL channels.

The unified (master or main or indicated) TCI state is TCI state of UE-dedicated reception on PDSCH/PDCCH or dynamic-grant/configured-grant based PUSCH and dedicated PUCCH resources.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state can be associated with a TRP of a cell having a PCI different from the PCI of the serving cell).

Quasi-co-location (QCL) relation, can be quasi-location with respect to one or more of the following relations [[REF 4]—section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter}

In addition, quasi-co-location relation and source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g. non-UE dedicated channel and sounding reference signal (SRS).

A UE is indicated a TCI state by MAC CE when the MAC CE activates one TCI state code point. The UE applies the TCI state code point after a beam application time from the corresponding HARQ-ACK feedback. A UE is indicated a TCI state by a DL related DCI format (e.g., DCI Format 1_1, or DCI format 1_2), wherein the DCI format includes a “transmission configuration indication” field that includes a TCI state code point out of the TCI state code points activated by a MAC CE. A DL related DCI format can be used to indicate a TCI state when the UE is activated with more than one TCI state code points. The DL related DCI format can be with a DL assignment for PDSCH reception or without a DL assignment. A TCI state can also be indicated in a purpose designed channel or DCI Format for TCI state indication. A TCI state (TCI state code point) indicated in a DL related DCI format or purpose design channel or DCI Format for TCI state indication is applied after a beam application time from the corresponding HARQ-ACK feedback.

In 5G/NR, a UE performs the cell search procedure to acquire time and frequency synchronization with a cell and to detect the physical layer Cell ID of the cell. To perform cell search, the UE receives the following signals and channel: (1) the primary synchronization signal (PSS), (2) the secondary synchronization signal (SSS) and (3) the physical broadcast channel (PBCH). A PSS/SSS/PBCH block (SS/PBCH block) is referred to as SSB and includes 4 consecutive symbols, and 20 resource blocks (RBs) (240 subcarriers), as illustrated in FIG. 7.

SSBs are organized in groups or bursts of up to N SSBs, transmitted within half a frame (5 ms), each SSB within the group or burst has an index i, where i=0, 1, . . . , N−1, within each group or burst of SSBs, the SSBs are time-division multiplexed and arranged in increasing order of i, with increasing time. For carrier frequencies less than or equal to 3 GHz, N=4. For carrier frequencies in FR1 that are larger than 3 GHz, N=8. For carrier frequencies in FR2, N=64. The SSB indices actually transmitted are provided by ssb-PositionsInBurst in system information block one (SIB1) or in ServingCellConfigCommon or in SSB-MTC-AdditionalPCI or in LTM-SSB-Config.

SSBs are transmitted periodically, where the allowed periodicities are {5, 10, 20, 40, 80, 160} ms. In addition to cell search, SSBs can also be used for beam management related procedures, such as new beam acquisition, beam measurements, and beam failure detection and recovery. Each SSB with index i can be associated with a spatial domain filter (or beam).

NR introduced a physical random access channel (PRACH) to be used, among other cases, when the UE wants to communicate with the network and doesn't have uplink resources. For example, the physical random access channel can be used during initial access. The PRACH includes a preamble format comprising one or more preamble sequences transmitted in a PRACH Occasion (RO).

NR supports four different preamble sequence lengths:
Sequence length 839 used with sub-carrier spacings 1.25 kHz and 5 kHz with unrestricted or restricted sets.
Sequence length 139 used with sub-carrier spacings 15 kHz, 30 kHz, 60 kHz and 120 kHz with unrestricted sets.
Sequence length 571 used with sub-carrier spacing 30 kHz with unrestricted sets.
Sequence length 1151 used with sub-carrier spacing 15 kHz with unrestricted sets.

RACH preambles are transmitted in time-frequency resources PRACH Occasions (ROs). Each RO determines the time and frequency resources in which a preamble is transmitted, the resources allocated to an RO in the frequency domain (e.g., number of RBs) and the resource allocated to an RO in the time domain (e.g., number of OFDMA symbols or number of slots), depend or the preamble sequence length, sub-carrier spacing of the preamble, sub-carrier spacing of the PUSCH in the UL BWP, and the preamble format. Multiple PRACH Occasions can be FDMed in one time instance. This is indicated by higher layer parameter msg1-FDM. The time instances of the PRACH Occasions are determined by the higher layer parameter prach-ConfigurationIndex, and Tables 6.3.3.2-2, 6.3.3.2-3, and 6.3.3.2-4 of [REF 1]v18.1.0.

SSBs are associated with ROs. The number of SSBs associated with one RO can be indicated by higher layer parameters such as ssb-perRACH-OccasionAndCB-PreamblesPerSSB and ssb-perRACH-Occasion. The number of SSBs per RO can be {⅛,¼,½,1,2,4,8,16}. When the number of SSBs per RO is less than 1, multiple ROs are associated with the same SSB index. SS/PBCH block indexes provided by ssb-PositionsInBurst in SIB1 or in ServingCellConfigCommon are mapped to valid PRACH occasions in the following order [[REF 3]v18.1.0]:
First, in increasing order of preamble indexes within a single PRACH occasion.
Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

The association period starts from frame 0 for mapping SS/PBCH block indexes to PRACH Occasions.

A random access procedure can be initiated by a PDCCH order, by the MAC entity, or by RRC.

There are two types of random access procedures, type-1 random access procedure and type-2 random access procedure.

Type-1 random access procedure also known as four-step random access procedure (4-step RACH), is as illustrated in FIG. 8;
In step 1, the UE transmits a random access preamble, also known as Msg1, to the gNB. The gNB attempts to receive and detect the preamble.
In step 2, the gNB upon receiving the preamble transmits a random access response (RAR), also known as Msg2, to the UE including, among other fields, a time adjustment (TA) command and a RAR uplink grant for a subsequent PUSCH transmission.
In step 3, the UE after receiving the RAR, transmits a PUSCH transmission scheduled by the grant of the RAR and time adjusted according to the TA received in the RAR. Msg3 or the PUSCH scheduled by the RAR UL grant can include the RRC setup request message.
In step 4, the gNB upon receiving the RRC setup message, allocates downlink and uplink resources that are transmitted in a downlink PDSCH transmission to the UE.

After the last step, the UE can proceed with reception and transmission of data traffic.

Type-1 random access procedure (4-step RACH) can be contention based random access (CBRA) or contention free random access (CFRA). The CFRA procedure ends after the random access response, the following messages are not part of the random access procedure. For CFRA, in step 0, the gNB indicates to the UE the preamble(s) to use.

Rel-16, introduced a new random access procedure; Type-2 random access procedure, also known as 2-step random access procedure (2-step RACH), is as illustrated in FIG. 9, that combines the preamble and PUSCH transmission into a single transmission from the UE to the gNB, which is known as MsgA. Similarly, the RAR and the PDSCH transmission (e.g. Msg4) are combined into a single downlink transmission from the gNB to the UE, which is known as MsgB.

A random access procedure can be triggered for initial access from the RRC_IDLE state. During this procedure, a UE identifies an SS/PBCH block with index i and with an RSRP that exceeds a threshold. The RSRP threshold for SSB selection for RACH resource association is indicated by the network. The UE selects a RO and a preamble within the RO associated with SS/PBCH block index i. The UE transmits a PRACH using the selected RO/preamble. The UE monitors and receives the random access response (RAR), by attempting to detect a DCI format 1_0 with CRC scrambled by a corresponding RA-RNTI during a window controlled by higher layers. If the UE does not detect the DCI format 1_0 with CRC scrambled by the corresponding RA-RNTI within the RAR window, the UE may retransmit PRACH. If the UE detects the DCI format 1_0 with CRC scrambled by the corresponding RA-RNTI, the UE receives a RAR UL grant for the scheduling of a PUSCH. The UE transmits the PUSCH according to the RAR UL grant. In response to the PUSCH transmission scheduled by a RAR UL grant, when a UE has not been provided a C-RNTI, the UE attempts to detect a DCI format 1_0 with CRC scrambled by a corresponding TC-RNTI scheduling a PDSCH that includes a UE contention resolution identity. The spatial domain filters (beams) identified during initial access, are used for subsequent transmissions and receptions to/from the UE until a single TCI state is configured or activated or indicated to the UE. For downlink receptions when a UE does not have the TCI state, the spatial domain filter is that associated with the SS/PBCH block index identified during initial access. For uplink transmissions when a UE does not have the TCI state, the spatial domain filter is that used for PUSCH scheduled by the RAR UL grant.

Sounding reference signal is an uplink reference signal that is used for sounding (i.e., channel state or quality estimation) the uplink channel between the UE and the gNB. In case of reciprocity between UL and DL, the channel sounding of the uplink channel can also be used for link adaptation and precoding on the downlink channel from the gNB to the UE. SRS is transmitted independent of data transmissions on the uplink. The SRS usage can be one of: beamManagement, codebook, nonCodebook, antennaSwitching, this is in addition to SRS for positioning.

In NR, SRS resources are configured by the network for example as part of RRC setup or RRC reconfiguration. SRS resources are configured in SRS resource set. An SRS resource set includes a set of SRS resource, and defines the following parameters: (1) resourceType, which determine the time domain behavior of SRS, SRS can be aperiodic, semi-persistent or periodic. (2) usage, which can be one of: beamManagement, codebook, nonCodebook or antennaSwitching. (3) information related to power control and TCI state.

The configuration of the SRS resource includes the following: (1) information related to the transmission comb, including comb size, comb offset and cyclic shift. (2) Information related to time domain resource mapping including starting symbol within a slot, number of SRS symbols and repetition factor. (3) information related to frequency domain including freqDomainPosition N_RRC, freqDomainShift n_shift, and frequency hopping parameters c-SRS, b-SRS, and b-hop. (4) Information related to group or sequence hopping, whether one of them or neither is enabled. (5) for periodic and semi-persistent SRS, the periodicity and offset of the SRS resource. (6) Sequence ID. (7) Information related to the TCI state or spatial relation info.

In 5G NR, a UE (e.g., the UE 116) can transmit a sounding reference signal (SRS). A SRS resource is configured by higher layer IE SRS-Resource.

The SRS sequence is a low PAPR sequence of length

$${N}_{ZC} = {M}_{sc , b}^{SRS}$$

given by:

$${r}^{( p )} ( n , {l}^{′} ) = {r}_{u , v}^{( α , δ )} ( n ) = {e}^{j α n} {\overline{r}}_{u , v} ( n ) , 0 \leq n < {M}_{ZC}$$

$$where {M}_{ZC} = {mN}_{sc}^{RB} / {2}^{δ} , δ = log ( {K}_{TC} ) ,$$

with K_{TC} being the transmission comb number is provided in higher layer IE transmissionComb, K_{TC}∈{2,4,8}. l′ is the SRS symbol within a SRS resource of a slot,

$${l}^{′} ∈ \{ 0 , 1 , … , {N}_{symb}^{SRS} - 1 \} , {N}_{symb}^{SRS}$$

is the number of SRS symbols in a slot. The cyclic shift αᵢ for antenna port pᵢ is given by

$${α}_{i} = 2 π \frac{{n}_{SRS}^{cs , i}}{{n}_{SRS}^{cs , max}} , and$$

$${n}_{SRS}^{cs , i} = ( {n}_{SRS}^{cs} + \frac{{n}_{SRS}^{cs , max} ( {p}_{i} - 1000 )}{{N}_{ap}^{SRS}} ) mod {n}_{SRS}^{cs , max} with {n}_{SRS}^{cs}$$

being provided by higher layer in IE transmissionComb,

$${n}_{SRS}^{cs , max}$$

depends on K_{TC} as illustrated in Table 3.

TABLE 3

| K_{TC} | ${n}_{SRS}^{cs , max}$ |
|---|---|
| 2 | 8 |
| 4 | 12 |
| 8 | 6 |

u is the group number u∈{0, 1, . . . , 29}, v is the base sequence number, with v∈{0}, if 6≤N_{ZC}≤60 and ∈{0,1}, if 60<N_{ZC}. The base sequence, r̅_{u,v}(n), is generated as follows:

| | |
|---|---|
| 1. | For N_{ZC} ∈ {6, 12, 18, 24}, r̅_{u,v}(n) = e^{jϕ(n)π/4}, with 0 ≤ n < M_{ZC} − 1. |
| | ϕ(n) is given by Tables 5.2.2.2-1 to 5.2.2.2-4 of TS [REF 1]. |
| 2. | $For {N}_{ZC} \geq 30 , {\overline{r}}_{u , v} ( n ) = {e}^{- j \frac{π ( u + 1 ) ( n + 1 ) ( n + 2 )}{31}} , with 0 \leq n \leq {M}_{ZC} - 1.$ |
| 3. | $For {N}_{ZC} \geq 30 , {\overline{r}}_{u , v} ( n ) = {x}_{q} ( n mod {N}_{ZC} ) , {x}_{q} ( n ) = {e}^{- j \frac{π qm ( m + 1 )}{{N}_{ZC}}} .$ |
| | N_{ZC} is the largest prime number less than |
| | ${M}_{ZC} \cdot q = ⌊ \overline{q} + 1 / 2 ⌋ + v \cdot {( - 1 )}^{⌊ 2 \overline{q} ⌋} \cdot \overline{q} = {N}_{ZC} \frac{u + 1}{31} .$ |

The sequence group u is given by:

$$u = ( {f}_{gh} ( {n}_{s , f}^{μ} , {l}^{′} ) + {n}_{ID}^{SRS} ) .$$

### Where,

$${n}_{ID}^{SRS}$$

is provided by higher layer parameter sequenceID, with

$${n}_{ID}^{SRS} ∈ \{ 0 , 1 , … , 65535 \} .$$

Higher layer parameter groupOrSequenceHopping determines the values of u and v:
if groupOrSequenceHopping equals ‘neither’, neither group, nor sequence hopping shall be used and

$${f}_{gh} ( {n}_{s , f}^{μ} , {l}^{′} ) = 0 ,$$

and v=0.
if groupOrSequenceHopping equals ‘groupHopping’, group hopping but not sequence hopping is used and v=0, and

$${f}_{gh} ( {n}_{s , f}^{μ} , {l}^{′} ) = ( {\sum }_{m = 0}^{7} c ( 8 ( {n}_{s , f}^{μ} {N}_{symb}^{slot} + {l}_{0} + {l}^{′} ) + m ) \cdot {2}^{m} ) mod 30 , {N}_{symb}^{slot}$$

is the number of symbols in a slots, l₀ is the first SRS symbols in the slot, and c(n) a length-31 Gold sequence defined as c(n)=(x₁(n+N_{c})+x₂(n+N_{c}))mod 2, with N_{c}=1600, x₁(n+31)=(x₁(n+3)+x₁(n))mod 2, x₂(n+31)=(x₂(n+3)+x₂(n+2)+x₂(n+1)+x₂(n))mod 2, the first m-sequence is initialized with x₁(0)=1, and x₁(n)=0, for n=1 . . . 30. The second m-sequence is initialized with cᵢₙᵢₜ, where

$${c}_{init} = {n}_{ID}^{SRS}$$

if groupOrSequenceHopping equals ‘sequenceHopping’, sequence hopping but not group hopping is used and

$${f}_{gh} ( {n}_{s , f}^{μ} , {l}^{′} ) = 0 and$$

$$v = \{ \begin{matrix}c ( {n}_{s , f}^{μ} {N}_{symb}^{slot} + {l}_{0} + {l}^{′} ) & {M}_{sc , b}^{SRS} \geq 6 {N}_{sc}^{RB} \\ 0 & otherwise\end{matrix}$$

$${N}_{symb}^{slot}$$

is the number of symbols in a slots, l₀ is the first SRS symbols in the slot, and c(n) a length-31 Gold sequence as previously defined.

The SRS sequence, r^{(p)}(n, l′), is mapped to resource elements

$${a}_{k , l}^{( p )}$$

within a slot, where k is the sub-carrier frequency, l is the symbol number within the slot and p is the antenna port, where for SRS there is one antenna port, given by

$${a}_{k , l}^{( p )} = {β}_{SRS} {r}^{( p )} ( {k}^{′} , {l}^{′} )$$

$$l = {l}^{′} + {l}_{0}$$

where,
β_{SRS} is a scaling factor,

$${k}^{′} = 0 , 1 , … , {M}_{sc , b}^{SRS} - 1 , {M}_{sc , b}^{SRS} = {m}_{SRS , b} {N}_{sc}^{RB} / {K}_{TC} , {m}_{SRS , b}$$

is provided by Table 6.4.14.3-1 of [REF 1], and

$${l}^{′} = 0 , 1 , … , {N}_{symb}^{SRS} - 1.$$

l=l′+l₀, with l₀ the first SRS symbols in the slot, where l₀ ∈{0, 1, . . . , 13}.

$$k = {K}_{TC} {k}^{′} + {k}_{0}^{( {p}_{i} )} ,$$

K_{TC} is the transmission comb number as previously described,

$${k}_{0}^{( p )} = {\overline{k}}_{0}^{( p )} + {\sum }_{b = 0}^{{B}_{SRS}} {K}_{TC} {M}_{sc , b}^{SRS} {n}_{b} , {\overline{k}}_{0}^{( pi )} = {n}_{shift} {N}_{sc}^{RB} + ( {k}_{TC}^{( pi )} + {k}_{offset}^{{l}^{′}} ) mod {K}_{TC} ,$$

$${k}_{TC}^{( pi )} = \{ \begin{matrix}( {\overline{k}}_{TC} + {K}_{TC} / 2 ) mod {K}_{TC} & \begin{matrix}if {n}_{SRS}^{cs} ∈ \{ \frac{{n}_{SRS}^{cs , max}}{2} , … , {n}_{SRS}^{cs , max} - 1 \} \\ and {N}_{ap}^{SRS} = 4 and {p}_{i} ∈ \{ 1001 , 1003 \}\end{matrix} \\ {\overline{k}}_{TC} & otherwise\end{matrix}$$

k̅_{TC} is the transmission comb offset included within higher layer IE transmissionComb, with \hat{k}_{TC}∈{0, 1, . . . , K_{TC}−1},

$${k}_{offset}^{{l}^{′}}$$

is a symbol dependent sub-carrier offset given by Table 4, n_{shift} is given by higher layer parameter freqDomainShift and it adjusts the frequency allocation with respect to a reference point. If

$${N}_{BWP}^{start} \leq {n}_{shift}$$

the reference point for

$${k}_{0}^{( p )}$$

is sub-carrier 0 in common resource block 0, otherwise the reference point is the lowest subcarrier of the BWP. n_{b} is a frequency positioning index. n_{b} is given by:

$${n}_{b} = ⌊ \frac{4 {n}_{RRC}}{{m}_{SRS , b}} ⌋ mod {N}_{b}$$

n_{RRC} is given by higher layer parameter freqDomainPosition, and m_{SRS,b} and N_{b} are determined by Table 6.4.14.3-1 of [REF 1] with b=B_{SRS} and the configured value of C_{SRS}.

TABLE 4

| | ${k}_{offset}^{0} , {k}_{offset}^{1} , … , {k}_{offset}^{{N}_{symb}^{SRS} - 1}$ | | | | |
|---|---|---|---|---|---|
| K_{TC} | ${N}_{symb}^{SRS} = 1$ | ${N}_{symb}^{SRS} = 2$ | ${N}_{symb}^{SRS} = 4$ | ${N}_{symb}^{SRS} = 8$ | ${N}_{symb}^{SRS} = 12$ |
| 2 | 0 | 0, 1 | 0, 1, 0, 1 | — | — |
| 4 | — | 0, 2 | 0, 2, 1, 3 | 0, 2, 1, 3, 0, 2, 1, 3 | 0, 2, 1, 3, 0, 2, 1, 3, 0, 2, 1, 3 |
| 8 | — | — | 0, 4, 2, 6 | 0, 4, 2, 6, 1, 5, 3, 7 | 0, 4, 2, 6, 1, 5, 3, 7, 0, 4, 2, 6 |

In NR, paging is used to alert idle and inactive UEs of incoming calls, messages and data. Paging is used to trigger RRC setup (e.g., RRC setup request or RRC connection resumption).

Paging is transmitted over the paging channel (PCH). The paging message includes a paging record list, which is a list of UEs being paged, each identified by a TMSI or an I-RNTI. The 5G S-Temporary Mobile Subscription Identifier (5G-S-TMSI), a temporary UE identity provided by the 5GC which uniquely identifies the UE within the tracking area. The I-RNTI is used to identify the suspended UE context of a UE in RRC_INACTIVE.

The following messages describe the contents of a paging message:

| | |
|---|---|
| PCCH-Message ::= | SEQUENCE { |
| message | PCCH-MessageType |

}

| | |
|---|---|
| PCCH-MessageType ::= | CHOICE { |
| c1 | CHOICE { |
| paging | Paging, |

```
    spare1 NULL
  },
```

| | |
|---|---|
| messageClassExtension | SEQUENCE { } |

}

| Paging ::= | SEQUENCE { | |
|---|---|---|
| pagingRecordList | PagingRecordList | OPTIONAL, -- |

Need N

| | | |
|---|---|---|
| lateNonCriticalExtension | OCTET STRING | OPTIONAL, |
| nonCriticalExtension | Paging-v1700-IEs | OPTIONAL |

}

| | |
|---|---|
| PagingRecordList ::= | SEQUENCE (SIZE(1..maxNrofPageRec)) OF PagingRecord |
| PagingRecord ::= | SEQUENCE { |
| ue-Identity | PagingUE-Identity, |
| accessType | ENUMERATED {non3GPP} OPTIONAL, -- Need N |

...
}

| | |
|---|---|
| PagingUE-Identity ::= | CHOICE { |
| ng-5G-S-TMSI | NG-5G-S-TMSI, |
| fullI-RNTI | I-RNTI-Value, |

...
}

| | |
|---|---|
| NG-5G-S-TMSI ::= | BIT STRING (SIZE (48)) |
| I-RNTI-Value ::= | BIT STRING (SIZE(40)) |

A UE may use Discontinuous Reception (DRX) in RRC_IDLE and RRC_INACTIVE state in order to reduce power consumption. The UE monitors one paging occasion (PO) per DRX cycle, T. Where, a PO is a set of PDCCH monitoring occasions and can include multiple time slots where paging DCI can be sent. A Paging Frame (PF) is one Radio Frame and may contain one or multiple PO(s) or starting point of a PO.

The PF and PO for paging are determined by the following equations:
SFN of the PF is determined by: (SFN+PF_offset)mod T=(T div N)*(UE_ID mod N)
The index i_s of the PO is determined by: is =floor (UE ID/N)mod Ns
   where,
T is the DRX cycle of the UE, determined by the shortest of the UE specific DRX value(s) and a default DRX value included in SIB1. (1) For CN-initiated paging, a default cycle is broadcast in system information. (2) For CN-initiated paging, a UE specific cycle can be configured via NAS signaling. (3) For RAN-initiated paging, a UE-specific cycle is configured via RRC signaling. A UE in RRC_IDLE uses the shortest of (1) and (2). A UE in RRC_INACTIVE uses the shortest of (1), (2) and (3).
N is a number of total paging frames in T, provided by nAndPagingFrameOffset in SIB1.
Ns is a number of paging occasions for a PF, provided by ns in SIB1
PF_offset is an offset used for PF determination, provided by nAndPagingFrameOffset in SIB1.
UE_ID: 5G-S-TMSI mod 1024

To minimize the probability of paging false alarms, which occur when a UE decodes the PCH due to another UE assigned to the same PO being paged, UEs assigned to the same PO are divided into sub-groups, a DCI carrying a paging early indication (PEI) is transmitted before the corresponding PO to indicate the sub-groups with paging messages in the PO. A UE that is not in the indicated sub-groups indicated by the PEI doesn't decode the corresponding PO. There can be up to 8 sub-groups. The subgroups can be CN controlled sub-groups (determined by the access and mobility function (AMF)), and/or UE-ID based sub-groups.

DCI format 2_7 is used for notifying the paging early indication and TRS availability indication for one or more UEs. DCI Format 2_7 has a CRC scrambled by PEI_RNTI. DCI Format 2_7 includes: (1) a paging indication field of size

$${N}_{PO}^{PEI} \cdot {N}_{SG}^{PO} , where , {N}_{PO}^{PEI}$$

is the number of paging occasions configured by higher layer parameter po-NumPerPEI, and

$${N}_{SG}^{PO}$$

is the number of sub-groups of a paging occasion configured by higher layer parameter subgroupsNumPerPO. Each bit in the field indicates one UE subgroup of a paging occasion. (2) TRS availability indication, which can be of size 1-6 bits, where the number of bits is equal to one plus the highest value of the indBitID(s) provided by the trs-ResourceSetConfig if configured; 0 bits otherwise. Each TRS resource set is configured with an ID i for the association with (i+1)-th indication bit.

This disclosure evaluates early transmission of SRS. In one example, early SRS can be transmitted when the UE is the INACTIVE state. In one example, early SRS can be transmitted when the UE is in the IDLE. To transmit SRS, the UE determines an SRS resource, a spatial domain transmission filter and a transmit power for the SRS resource. The determination of the resource at the UE, can be by indication from the network (e.g., the network 130), or determination at the UE based on a rule, or a combination of both. SRS resource can include time and frequency resources (e.g., time unit and frequency unit), comb size and comb offset, sequence, cyclic shift, etc. A time unit can include, one or more symbols, one or more slots, one or more sub-frames, one or more frames, and/or a duration in units of time, e.g., micro-seconds or milliseconds, or seconds, etc. A frequency unit can include one or more sub-carriers, one or more resource blocks (RBs), one or more sub-channels, where a sub-channel is a group of RBs, and/or a frequency span in units of frequency (e.g., Hz or kHz, MHz, . . . ), etc. A spatial domain transmission filter can correspond to a transmit beam to transmit a channel or signal (e.g., SRS), in a certain direction (e.g., beam direction) and within a certain beam width. Transmit power can include several components, such as open loop power control components, e.g., based on pathloss loss, and closed loop power control, e.g., based on indication of transmit power control (TPC) commands from the network. In this disclosure the determination of the spatial domain transmit filter of early SRS and the determination of the transmit power of early SRS is evaluated.

When a UE is in RRC_IDLE state or RRC_INACTIVE state, and data arrives at the network for the UE, or data arrives at the UE for the network, the UE through RRC setup procedure or RRC reconfiguration procedure transitions to the RRC_CONNECTED state. After transitioning to the RRC_CONNECTED state the network can trigger SRS transmission from the UE for channel state or quality estimation and the UE can start transmitting and receiving data. This is illustrated in FIG. 10. The SRS trigger can be for wideband SRS or for sub-band SRS, which would require several SRS transmission instances to provide an estimate of the channel state or quality of the full bandwidth. This process, i.e., the estimation of the channel state or quality, can take tens of milliseconds, and even longer with sub-band SRS. Data transmission/reception can be delayed until the channel state or quality has been estimated using SRS, hence increasing latency. Alternatively, data transmission/reception can proceed in parallel with the SRS transmission and by the time the channel state or quality is estimated, the data (depending on the amount of data) has already or mostly been transmitted or received, hence rendering the channel state or quality estimation less useful while preceding transmissions/receptions from/to the UE are with reduced spectral efficiency due to the absence of a channel state or quality estimate at the gNB (e.g., the BS 102) for the UE.

To mitigate this issue, it is beneficial to have the channel state or quality estimated in parallel with the RRC setup procedure, or RRC reconfiguration procedure such that when the UE is ready to transmit or receive data at the completion of the setup or reconfiguration procedures, the channel state or quality has already been estimated and link adaptation and precoding for uplink or downlink data is based on the estimated channel state or quality. Hence, there is a benefit for transmitting SRS in parallel with RRC setup procedure, or RRC reconfiguration procedure to reduce latency as illustrated in FIG. 11. Furthermore, the RRC setup messages can benefit from the channel state or quality estimation performed by early SRS. For example, in FIG. 11, if channel information from early SRS is known before the exchange of registration, authentication and security messages, the channel information can be leveraged for the transmission of these message, hence providing a more efficient message exchange.

In variant examples of this disclosure, a UE in IDLE or INACTIVE states has data to transmit to the network, the UE transmits this data while in IDLE or INACTIVE states and doesn't transition to the CONNECTED mode. In this example, early SRS can be triggered before (Example 1 of FIG. 12) or during (Example 2 of FIG. 12) the data transmission. Data transmissions after the channel has been sounded by early SRS can leverage the channel state information for more efficient data transfer.

In variant examples of this disclosure, a UE in CONNECTED state has data to transmit to the network. In these examples, early SRS can be triggered before (Example 1 of FIG. 13) or during (Example 2 of FIG. 13) the data transmission. Data transmissions after the channel has been sounded by early SRS can leverage the channel state information for more efficient data transfer.

FIG. 19 illustrates a diagram of an example early SRS area (ESA) 1900 according to embodiments of the present disclosure. For example, ESA 1900 can be implemented within the wireless network 100 of FIG. 1. This example is for illustration only and other embodiments can be used without departing from the scope of the present disclosure.

When transmitting early SRS, in addition to determining the resources, the UE determines the transmit power and spatial domain transmission filter for transmission. When transmitting early SRS, during IDLE or INACTIVE states the UE has not established a link yet with the network. Furthermore, the UE can be within an area compromising one or more cells, in this disclosure such area is referred to as the early SRS area (ESA). This is illustrated in FIG. 19. The UE selects the TRP or cell to transmit the early SRS to and determines the transmission power to satisfy certain conditions, e.g., based on the pathloss RS and the power control parameters. In this disclosure, how the UE can determine the spatial domain transmission filter and transmission power of early SRS is evaluated.

The present disclosure relates to a 5G/NR and/or 6G communication system.

This disclosure evaluates aspects related to design of early SRS. This disclosure includes the following:
Configuration of early SRS area (ESA).
Configuration of SRS resources in ESA.
Spatial domain transmission filter for early SRS.
Determination of power control parameters for early SRS.
Transmission power for early SRS.

In the following, both FDD and TDD are regarded as a duplex method for DL and UL signaling. In addition, full duplex (XDD) operation is possible, e.g., sub-band full duplex (SBFD) or single frequency full duplex (SFFD).

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure evaluates several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based signaling (e.g., SIB1 or other SIB) wherein the information can be common/cell-specific information or dedicated/UE-specific information or (2) RRC dedicated signaling that is sent to a specific UE or (3) UE-group RRC signaling.

In this disclosure MAC CE signaling can be UE-specific e.g., to one UE or can be UE common (e.g., to a group of UEs or all UEs in a cell). MAC CE signaling can be DL MAC CE signaling or UL MAC CE signaling.

In this disclosure L1 control signaling includes: (1) DL control information (e.g., DCI on PDCCH or DL control information on PDSCH) and/or (2) UL control information (e.g., UCI on PUCCH or PUSCH). L1 control signaling can be UE-specific e.g., to one UE or can be UE common (e.g., to a group of UEs or all UEs in a cell).

In this disclosure a list with N elements can be denoted as L(i), where i can take N values, and L(i) can correspond to the element or entry associated with index i. In one example, i can take N arbitrary values. In one example, i=0, 1, . . . , N−1. In one example, i=1, 2, . . . , N. In one example, i is an identity of an element in the list.

In the present disclosure, the term “activation” describes an operation wherein a UE (e.g., the UE 116) receives and decodes first information provided by a first signal from the network (or gNB) and, based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and, based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

Terminology such as TCI, TCI states, SpatialRelationInfo, target RS, reference RS, and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SSB) with the result of the measurement used for calculating a beam report (e.g., including at least one L1-RSRP/L1-SINR accompanied by at least one CRI or SSBRI). As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the needed information to assign a particular DL (or/and UL) TX beam to the UE, for example in case of channel reciprocity.

In this disclosure, DCI Format is used for L1 control information in the DL direction from gNB to UE. DCI Format (i.e., L1 control information) can be single stage/part control information or two stage/part control information. In one example, the DCI format can be carried on a physical downlink control channel (PDCCH). In one example, DCI format can be carried on a physical downlink shared channel (PDSCH). In one example, DCI can be split between PDCCH (e.g., for a first part) and PDSCH (e.g. for a second part). In one example, DCI can be split between a first PDCCH (e.g., for a first part) and a second PDCCH (e.g. for a second part).

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, for example, a frequency-unit can be a sub-carrier or a resource block (RB) or a sub-channel, wherein a sub-channel is a group of RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

In this disclosure, a higher layer message (e.g., SIB-based or RRC-based or MAC CE-based) can be carried by a physical downlink shared channel (PDSCH). In one example, the PDSCH can be scheduled by a DCI format.

In one example, the configuration of early SRS resources can be configured or updated, by SIB signaling and/or RRC signaling and/or MAC CE signaling and/or L1 control signaling.

In one example, the configuration of the SRS resource or SRS resource set can include:
SRS resource ID or resource set ID
Time and frequency resources (e.g., symbols within a slot for SRS, starting symbol for SRS, number of repetitions, number of symbols for SRS, time slot and/or subframe and/or frame for SRS, periodicity and offset of SRS (e.g., in case of periodic or semi-persistent SRS), starting PRB/sub-carrier/sub-channel (a sub-channel is a group of PRBs) for SRS, number of PRBs/sub-carriers/sub-channels for SRS, whether frequency hopping is enabled and if enabled frequency hopping pattern, etc.).
Number of instances, K, of SRS transmitted when SRS is triggered.
Comb size, comb offset and cycle shift.
Sequence for reference signal.
Spatial relation or TCI state information for SRS. Whether or not an SRS resource follows the unified or indicated TCI state. If TCI state (e.g., unified TCI state) includes more than one TCI state (e.g., more than one UL TCI state and/or more than joint TCI state), which of the more than one TCI states to apply.
Power for reference signal.

With reference to FIG. 14, an example of embodiments of this disclosure is shown. A UE can be configured with SRS resources and/or SRS resource sets by system information (e.g., SIB, e.g., SIB1 or other SIB) or by RRC configuration. The UE can be indicated or determines to transmit SRS. The UE, based on the indication or determination of SRS transmission, and the configured SRS resources, transmits SRS in one or more SRS transmission instances. In one example, the transmission is one-shot (e.g., one SRS transmission instance, or one SRS transmission instance per sub-band). In one example, the transmission is N-shot (e.g., N SRS transmission instances, or N SRS transmission instances per sub-band). In one example, the transmission is periodic. In one example, a UE can optionally determine or is indicated to stop SRS transmission (for example in case of periodic SRS transmission, or in case of N-shot SRS transmission). In one example, the SRS transmission is towards one cell or one TRP or uses one spatial domain transmission filter (one beam or one TCI state or one spatial relation), e.g., the spatial domain transmission filter and/or the transmit power of SRS is determined based on a reference signal (e.g., SSB or CSI-RS) transmitted from the cell or TRP. In one example, the SRS transmission can be towards more than one cell or more than one TRP or uses more than one spatial domain transmission filter (more than one beam or more than one TCI state or more than one spatial relation), e.g., the spatial domain transmission filters and/or the transmit power of SRS is determined based on a reference signals (e.g., SSB or CSI-RS) transmitted from the more than one cell or the more than one TRP.

In one example, resources used for SRS transmission, can be one of a set or group of resources configured by the network, e.g., by system information (SIB, e.g., SIB1 or other SIB) or RRC configuration. The SRS resource ID (or SRS resource set ID), e.g., of an SRS resource (or SRS resource set), can be indicated and/or determined by the UE. In one example, the configuration of the SRS resource parameters or a subset of the SRS resource parameters can be indicated to the UE.

In one example, an SRS transmission triggered as described in this disclosure can be one of.
A single instance SRS transmission. In one example, the single transmission instance is for the SRS resource. In one example, the single transmission instance is per sub-band of SRS.
K instances of SRS transmissions. Wherein, K can be defined in the system specifications and/or configured or updated by system information and/or SIB signaling and/or RRC signaling and/or MAC CE signaling and/or L1 control signaling (e.g., DCI Format). In one example, the K transmission instances are for the SRS resource (e.g., these can be over a wideband or multiple sub-bands). In one example, the K transmission instances are per sub-band of SRS (e.g., each sub-band of SRS is transmitted in K transmission instances). Optionally, the UE can be indicated or determines to early terminate SRS transmissions.
A periodical or semi-persistent transmission until a reconfiguration message or deactivation message is transmitted to the UE, e.g., to stop the SRS transmission.

In one example, SRS is sub-band SRS. The number of sub-bands within the full band is N. In one example, SRS is transmitted K times when triggered. In one example K=N, In one example, K>=N. In one example, a hopping pattern is used to sweep the SRS transmission in the different sub-bands, as illustrated in FIG. 17.

With reference to FIG. 17, an example is shown with 4 sub-bands in the full band (i.e., N=4). SRS is transmitted in 4 different SRS instances at different frequency locations to estimate the quality of the channel in the full band.

In one example, a UE is configured a validity area for early SRS, e.g., early SRS area (ESA). In one example, the ESA is one cell. In one example, the ESA is a list of cells up to a maximum number of cells. In one example, a cell is identified by a cell identity (e.g., a bit string of length 36-bits). In one example a cell is identified by a physical cell identity (PCI).

In one example, the configuration of the ESA is provided by system information block (SIB) signaling. In one example, the configuration of the ESA is provided by RRC config. In one example, the configuration of the ESA is provided by suspend configuration.

In one example, a configuration of early SRS is provided to the UE. In one example, the configuration of early SRS can include one or more of the following:
Configuration of early SRS area (ESA) as mentioned herein. In one example, if the configuration of the ESA is not provided, the ESA may be the cell associated with a SIB containing the early SRS configuration, for example, the association maybe based on the cell of the SS/PBCH synchronization block (SSB) used to receive the SIB (e.g., providing the spatial filter for the SIB). In one example, if the configuration of the ESA is not provided, the ESA may be the cell providing the RRC message containing the early SRS configuration (e.g., the cell providing the early SRS configuration). In one example, if the configuration of the ESA is not provided, the ESA may be the cell the UE is in when UE enters the INACTIVE state (e.g., receive RRC release message to become INACTIVE).
A configuration of early SRS resources for the normal UL (NUL) carrier, e.g., provided by srs-EarlyConfig for a NUL carrier.
A configuration of early SRS resources for supplement UL (SUL) carrier e.g., provided by srs-EarlyConfig for a SUL carrier.
A configuration of the NUL carrier bandwidth part (BWP) for early SRS. In one example, if a configuration of the NUL carrier BWP is not provided, the initial UL BWP is used for early SRS. In one example, if a configuration of the NUL carrier BWP is not provided, the active bandwidth part before the UE transitions to the INACTIVE state is used for early SRS.
A configuration of the SUL carrier bandwidth part (BWP) for early SRS. In one example, if a configuration of the SUL carrier BWP is not provided, the initial UL BWP is used for early SRS. In one example, if a configuration of the SUL carrier BWP is not provided, the active bandwidth part before the UE transitions to the INACTIVE state is used for early SRS.

In the examples mentioned herein, a BWP configuration can include:
Location and bandwidth, providing the frequency domain location and bandwidth of the BWP. The value of the field shall be interpreted as resource indicator value (RIV). The first RB is a RB determined by subcarrierSpacing of this BWP and offsetToCarrier.
Sub-carrier spacing used for the BWP.
Cyclic-prefix used for the BWP. This can be normal cyclic prefix or extended cyclic prefix.

In one example, a configuration of early SRS (e.g., srs-EarlyConfig) can include:
A configuration of early SRS resource sets, e.g., one or more SRS resource sets for early SRS. In one example, an SRS resource set can be identified by an SRS resource set ID for early SRS.
A configuration of early SRS resources, e.g., one or more SRS resources for early SRS. In one example, an SRS resource can be identified by an SRS resource ID for early SRS.
Tpc-accumulation. This field can indicate whether TPC accumulation for early SRS is enabled or disabled. In one example, closed loop power control doesn't apply to early SRS and there is no TPC accumulation configuration.

In one example, the configuration of an SRS resource set for early SRS can include one or more of the following parameters:
SRS resource set ID. In one example, the SRS resource set ID is commonly configured across cells within early SRS area (ESA).
A list of SRS resource IDs for early SRS. In one example, the list of SRS resource IDs for early SRS is commonly configured across cells within early SRS area (ESA).
Time domain SRS resource configuration (e.g., resource type) (e.g., periodic, or semi-persistent or aperiodic (if applicable)).
Usage of early SRS. In one example, the usage of early SRS can be antenna switching or codebook, or non-codebook, or beam management. In one example, the usage of early SRS is antenna switching. In one example, the usage of early SRS is beam management. In one example, the usage of early SRS is codebook. In one example, the usage of early SRS is non-codebook.
Power control parameters. Wherein, power control parameters can include p0 and alpha. p0 is an open loop power control parameter, alpha is a fractional path loss coefficient. In one example, p0 and alpha apply to cells within early SRS area (ESA). In one example, the power control parameters are included in a TCI state. In one example, the power control parameters are included in early SRS resource configuration.
Power control adjustment state. In one example, power control adjustment state can indicate whether early SRS applies closed loop power control or not. In one example, power control adjustment state can indicate the number of power control adjustment states. In one example, there is no configuration for power control adjustment state, early SRS doesn't apply closed loop power control. In one example, power control adjustment state indicates whether SRS follows PUSCH power control adjustment state(s) (and in some cases which one), or whether SRS has a separate power control adjustment(s). In one example, the power control adjustment state is included in early SRS resource configuration.
Pathloss reference signal to be used to estimate the downlink pathloss and early SRS transmit power. In a variant example, the pathloss reference signal is provided by early SRS resource. In a variant example, the pathloss reference signal is signaled by dynamic signaling (e.g., L1 control signaling (e.g., (DCI)) or higher layer dynamic signaling (e.g., MAC CE or RRC message). In a variant example, multiple candidate pathloss RS for power control are configured, and one of these candidate pathloss RS is signaled (e.g., with the SRS resources or by dynamic signaling as mentioned herein). In one example, a pathloss RS is a SS/PBCH block (SSB). In one example, a pathloss RS is channel state information reference signal (CSI-RS). In one example, a pathloss RS is a low-power synchronization signal (LP-SS). In a variant example, multiple candidate pathloss RS for power control are configured (e.g., configured pathloss RS can be SSB and/or CSI-RS and/or LP-SS), a UE selects a pathloss RS from the multiple candidate pathloss RS based on a condition and/or UE implementation. In one example, the condition can be that the pathloss RS has RSRP or SINR or quality that exceeds a threshold, wherein the threshold can be configured and/or updated by RRC signaling and/or MAC CE signaling and/or L1 control (e.g., DCI Format) signaling. In one example, the condition can be that the pathloss RS has largest RSRP or SINR or RSRQ or quality. In one example, the list of reference signals that the UE can use as a pathloss RS is configured outside the SRS configuration. In one example, pathloss RS can be a signal associated within the cells of ESA, for example, the pathloss RS is an SSB of a cell within the cells of the ESA and the UE selects pathloss RS with a RSRP or SINR or RSRQ or quality that exceeds a threshold or with the highest RSRP or SINR or quality, wherein the threshold can be configured and/or updated by SIB and/or RRC signaling and/or MAC CE signaling and/or L1 control (e.g., DCI Format) signaling. In one example, the pathloss RS is included in a TCI state.
TCI state (e.g., UL TCI state or joint TCI state) or spatial relation to be used to determine the spatial filter for transmission of early SRS. In a variant example, TCI state or spatial relation is not provided, and UE determines spatial domain transmission filter based a selected DL reference signal (SSB or CSI-RS or LP-SS), for example, the UE selects DL RS with a RSRP or SINR or RSRQ or quality that exceeds a threshold or with the highest RSRP or SINR or RSRQ or quality. In a variant example, a list of TCI states (e.g., UL TCI states or joint TCI states) or spatial relations is configured, a UE is indicated by L1 control (e.g., DCI Format) signaling and/or MAC CE signaling and/or RRC signaling a TCI state or spatial relation from the list of TCI states. In a variant example, a list of TCI states (e.g., UL TCI states or joint TCI states) or spatial relations is configured, a UE selects a TCI state or spatial relation from the list of TCI states or spatial relations based on a condition and/or UE implementation. In one example, the condition can be that the source RS (e.g., QCL Type D source RS or source RS for spatial relation) of the TCI state or spatial relation has RSRP or SINR or RSRQ or quality that exceeds a threshold, wherein the threshold can be configured and/or updated by SIB and/or RRC signaling and/or MAC CE signaling and/or L1 control (e.g., DCI) signaling. In one example, the condition can be that the source RS (e.g., QCL Type D source RS or source RS for spatial relation) of the TCI state or spatial relation has largest RSRP or SINR or RSRQ or quality. In one example, the list of TCI states or spatial relations that the UE can use for early SRS transmission is configured outside the SRS configuration. In one example, a UE is configured a TCI state or spatial relation for an early SRS resource. In one example, a TCI state includes power control parameters. In one example, a TCI state includes a pathloss RS.

In one example, the configuration of an SRS resource for early SRS can include one or more of the following parameters:
SRS resource ID. In one example, the SRS resource ID is commonly configured across cells within early SRS area (ESA).
Number of SRS ports. In one example, the number of RS ports can be 1, 2, 4 or 8 SRS ports. In one example, for early SRS, the number of SRS ports is 1.
Phase tracking reference signal (PTRS) port ID.
Transmission comb. In one example, the transmission comb can include a comb value (e.g., 2 or 4 or 8), a comb offset, and/or a cyclic shift. In one example, the transmission comb applies to cells in the ESA.
Resource mapping of early SRS within a slot. In one example, resource mapping applies to cells in the ESA. In one example, the resource mapping can be determined by one or more of the following
   Start position of early SRS within a slot. In one example, the start position is relative to the end of the slot, for example, start position 0 is the last symbol of the slot. Start position 1, is the second from last symbol of the slot and so on. In one example, the start position is relative to the start of the slot, for example, start position 0 is the first symbol of the slot. Start position 1, is the second symbol of the slot and so on.
   Number of symbols. In one example, for early SRS, the number of symbols is 1. In one example, for early SRS the number of symbols can be larger than 1.
   Repetition factor. In one example, for early SRS the repetition factor is 1. In one example, for early SRS the repetition factor can be larger than 1.
   Bitmap of SRS symbols in a slot.
Time domain SRS resource configuration (e.g., resource type) (e.g., periodic, or semi-persistent or aperiodic (if applicable)). In on example, if time domain resource configuration is configured in SRS resource set, the time domain resource configuration of SRS resource matches that of the corresponding SRS resource set. In one example, time domain SRS configuration applies to cells in the ESA. In one example, time domain resource configuration can include:
   Periodicity and offset within periodicity. In one example, SRS resources in same SRS resource set for early SRS can have a same periodicity.
Location of SRS in frequency domain.
   In one example, the early SRS allocation with respect to a reference point grid is provided by a higher layer parameter “Frequency domain shift (freqDomainShift)”. In one example, freqDomainShift applies to cells in the ESA.
   In one example, a higher layer frequency domain position (freqDomainPosition) determine the frequency position index.
Frequency hopping parameters (e.g., c-SRS, b-SRS and b-hop). In one example, the frequency hopping parameters apply to cells in the ESA.
Group or sequence hopping. In one example, group or sequence hopping can indicate group hopping or sequence hopping, or neither group or sequence hopping. In one example, group or sequence hopping applies to cells in the ESA.
Sequence ID. In one example, the sequence ID is used to initialize pseudo random group and sequence hopping. In one example, sequence ID applies to cells in the ESA.
TCI state or spatial relation info, e.g., as aforementioned.
Pathloss RS, e.g., as aforementioned.
Power control parameters, e.g., as aforementioned.

In one example, the configuration of early SRS is provided by system information block (SIB, e.g., SIB1 or other SIB) signaling. In one example, the configuration of early SRS is provided by RRC config. In one example, the configuration of early SRS is provided by suspend configuration.

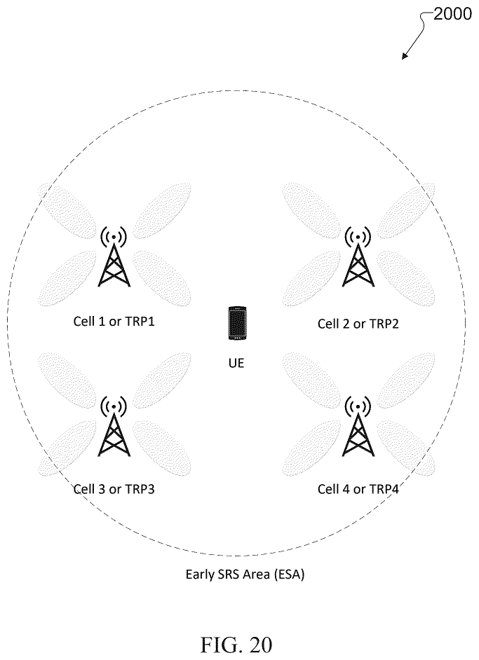

In one example, early SRS area (ESA) can include one or more cells or TRPs are illustrated in FIG. 20. A UE is located in the ESA. In one example, a UE determines a cell and/or a TRP and/or a beam (e.g., spatial domain filter or a corresponding DL RS) to transmit the early SRS towards. In one example, a UE can determine one or more cells and/or one or more TRPs and/or one or more beams (e.g., spatial domain filter or a corresponding DL RS) to transmit the early SRS towards.

In one example, a TRP or cell transmits a DL signal (DL RS), and the UE measures a RSRP or a SINR or a RSRQ or a quality associated with the DL signal (or DL RS). The DL signal or DL RS can be one or more of the following:
SS/PBCH block (SSB).
   In one example, the UE is provided by configuration a list of SSBs in cells in ESA. In one example, the SSBs can be cell defining SSBs (CD-SSBs). In one example, the SSBs can be non-cell defining SSBs (NCD-SSBs). In one example, the configuration can include one or more of the following parameters:
      Physical cell ID (PCI). In one example, if the physical cell ID (PCI) is not provided, the UE determines the PCI based on SSB reception and measurement (e.g., decoding PCI based on SSB).
      SSB index. In one example, if the SSB index is not provided, the UE determines the index based on SSB reception and measurement (e.g., decoding SSB index based on SSB).
      Absolute Radio frequency channel number (ARFCN) of SSB. In one example the ARFCN of cells in ESA can be different. In one example the ARFCN of cells in ESA are the same.
      Half frame index of SSB. In one example, the SSB can be in the first half frame (e.g., value 0). In one example, the SSB can be in the second half frame (e.g., value 1).
      Sub-carrier spacing of SSB. In one example, SSB sub-carrier spacing of cells in ESA are the same. In one example, if SSB sub-carrier spacing of a cell other than the last active cell (e.g., serving cells) is absent, a LIE applies the same SSB sub-carrier spacing as the last active cell. The last active cell, is the active cell (e.g., serving cell) right before the LIE enters into INACTIVE state or IDLE state.
      Periodicity of SSB. In one example, the SSB periodicity of cells in ESA are the same. In one example, if SSB periodicity of a cell other than the last active cell (e.g., serving cell) is absent, a LIE applies the same SSB periodicity as the last active cell. In one example, if SSB periodicity is absent, the LIE applies 5 ms.
      The SFN offset of the transmitted SSB relative to the start of the SSB period. Value 0 indicates that the SSB is transmitted in the first system frame, value 1 indicates that SSB is transmitted in the second system frame and so on. The network (e.g., the network 130) configures this field according to the field ssb-Periodicity such that the indicated system frame does not exceed the configured SSB periodicity. In one example, if the SFN offset exceeds the ssb-Periodicity, the offset is determined as SFN offset % ssb-Periodicity, where % is the modulo operator.
      The time offset of the SFN0 slot 0 for the cell with respect to SFN0 slot 0 of the last active cell (e.g., serving cell). The time offset can be in number of frames and/or number of subframes and/or number of slots.
      The average energy per resource element (EPRE) of the resource elements that carry secondary synchronization signals in dBm that the NW used for SSB transmission. In one example, the SSB EPRE of cells in ESA are the same. In one example, the SSB EPRE of cells in ESA can be different. In one example, if SSB EPRE of a cell other than the last active cell (e.g., serving cell) is absent, a UE applies the same SSB EPRE as the last active cell. In one example, a UE determines the EPRE after decoding the corresponding SIB1. In one example, a UE determines the ERPE after decoding the corresponding master information block (MIB).
   In one example, a UE (e.g., the UE 116) is not provided a configuration of SSBs. The UE determines the SSBs by reception and measurement of the SSBs. In one example, a UE may be provided a list of cell identities as mentioned herein. In one example, a UE evaluates SSBs belonging to the cells in the list of cells identities. In one example, a UE may be provided a list of physical cell identities (PCIs). In one example, a UE evaluates SSBs belonging to the cells in the list of PCIs.
Channels state information reference signals (CSI-RS). In one example, the UE is provided a configuration of CSI-RS for cells in ESA. In one example, the configuration can include:
   A configuration of CSI-RS resource sets, e.g., one or more CSI-RS resource sets. In one example, CSI-RS resource set can be identified by a CSI-RS resource set ID.
   A configuration of CSI-RS resources, e.g., one or more CSI-RS resources. In one example, CSI-RS resource can be identified by a CSI-RS resource ID.
Low power synchronization signal (LP-SS). In one example, the UE is provided a configuration of LP-SS.

In one example, the configuration of DL signal or DL RS (e.g., SSB or CSI-RS or LP-SS) is provided by system information block (SIB) signaling. In one example, the configuration of DL signal or DL RS (e.g., SSB or CSI-RS or LP-SS) is provided by RRC config. In one example, the configuration of DL signal or DL RS (e.g., SSB or CSI-RS or LP-SS) is provided by suspend configuration.

In one example, the UE measures the DL signal or DL RS provided as mentioned herein. In one example, the UE determines a quality metric, wherein the quality metric can be a reference signal receive power (RSRP), or signal to interference and noise ratio (SINR), or reference signal received quality (RSRQ), or other quality metrics. In one example, the quality metric can be based on a single measurement (e.g., based on a measurement of the DL signal or DL RS in a time-unit, e.g., slot). In one example, the quality metric can be based on an average of multiple measurements, wherein a measurement of the multiple measurements is based on a measurement of the DL signal or DL RS in a time-unit, e.g., slot. In one example, the average is a sliding window average within a time period T or a number of most recent instances N, wherein T and/or N can be configured or updated by RRC signaling and/or MAC CE signaling and/or L1 control (e.g., DCI Format) signaling.

In one example, the average is an exponential average e.g., if the quality metric in instance n is Q(n), and the quality metric in instance n−1 is Q(n−1) and measured quality metric in instance n is Qᵢₙₛ(n); Q(n)=αQ(n−1)+(1−α)Qᵢₙₛ(n) or (n)=(1−α)Q(n−1)+αQᵢₙₛ(n) wherein a, the exponential averaging coefficient, can be configured or updated by RRC signaling and/or MAC CE signaling and/or L1 control (e.g., DCI Format) signaling.

In one example, a UE determines a DL signal or DL RS, with a quality metric, as mentioned herein that exceeds a threshold. In one example, the threshold can be configured or updated by RRC signaling and/or MAC CE signaling and/or L1 control (e.g., DCI Format) signaling.

In one example, a UE determines a DL signal or DL RS, with a quality metric, as mentioned herein, the UE determines the M DL signals or DL RS with the largest metrics. In one example, M can be configured or updated by SIB or RRC signaling and/or MAC CE signaling and/or L1 control (e.g., DCI Format) signaling. In one example, M=1, i.e., the UE determines the DL signal or DL RS with the largest metric. In one example, M is specified in the system specifications.

In one example, a UE determines a DL signal or DL RS, with a quality metric, as mentioned herein that exceeds a threshold M times during a time period T (e.g., used to start a timer) or during N instances (e.g., N consecutive instances), wherein the threshold and/or M and/or N and/or T can be configured or updated by SIB RRC signaling and/or MAC CE signaling and/or L1 control (e.g., DCI Format) signaling.

FIG. 20 illustrates a diagram of an example ESA 2000 according to embodiments of the present disclosure. For example, ESA 2000 can be implemented within the wireless network 100 of FIG. 1. This example is for illustration only and other embodiments can be used without departing from the scope of the present disclosure.

In one example, the determined DL signal or DL RS is associated with a cell and/or a TRP and/or a beam. In one example, UE transmits early SRS towards one determined cell and/or TRP and/or beam. In one example, UE can transmit early SRS towards more than one determined cells and/or TRPs and/or beams.

In one example, the determined DL signal or DL RS is associated with a cell and/or a TRP and/or a beam. In one example, UE transmits a signal or channel, from UE to network, to trigger or indicate early SRS towards one determined cell and/or TRP and/or beam. In one example, UE can transmit the signal or channel, from UE to network, to trigger or indicate early SRS towards more than one determined cells and/or TRPs and/or beams. The UE transmits the early SRS using the same spatial relation as that of the signal/channel triggering or indicating early SRS from UE to network.

In one example, the signal/channel triggering or indicating early SRS from UE to network is PRACH preamble (e.g., Msg1 of type-1 random access procedure). In one example, the signal/channel triggering or indicating early SRS from UE to network Msg3 of type-1 random access procedure. In one example, the signal/channel triggering or indicating early SRS from UE to network is PRACH preamble (e.g., MsgA PRACH of type-2 random access procedure). In one example, the signal/channel triggering or indicating early SRS from UE to network is MsgA PUSCH of type-2 random access procedure).

In one example, if the configuration of the early SRS resources, or signal/channel triggering or indicating early SRS from UE to network, is associated with or includes a DL signal or DL RS, the UE determines the early SRS resource(s), or signal/channel triggering or indicating early SRS from UE to network, to transmit based on the determined DL signal(s) or DL RS(es) and the association or presence of the determine DL signal(s) or DL RS(es) in the early SRS resource(es).

In one example, if the configuration of the early SRS resources, or signal/channel triggering or indicating early SRS from UE to network, is associated with or includes a TCI state or a spatial relation, the UE determines the early SRS resource(s) to transmit based on the determined DL signal(s) or DL RS(es), wherein the determined DL signal(s) or DL RS(es) are source reference signals of the TCI state(s) or spatial relation(s) of the early SRS resource(s).

In one example, if the configuration of the early SRS resources, or signal/channel triggering or indicating early SRS from UE to network, is associated with or includes a pathloss RS, the UE determines the early SRS resource(s) to transmit based on the determined DL signal(s) or DL RS(es), wherein the determined DL signal(s) or DL RS(es) are path loss (PL) RS(es) of the early SRS resource(s) or source reference signals of PL RS(es) of the early SRS resource(s).

In one example, the UE determines spatial filter for transmission of the early SRS, or signal/channel triggering or indicating early SRS from UE to network, based on:
Beam correspondence with the determined DL signal or DL RS, wherein the DL signal or DL RS is determined as mentioned herein.
Based on a TCI state, wherein the TCI state has the determined DL signal or DL RS as its source RS (direct or indirect) (e.g., QCL Type D source RS or source RS for spatial relation). Wherein the DL signal or DL RS is determined as mentioned herein. In one example, the TCI state is a UL TCI state. In one example, the TCI state is a joint TCI state. In one example, a TCI state configuration is provided as mentioned herein.
Based on spatial relation, wherein the spatial relation is associated with the determined DL signal or DL RS, wherein the DL signal or DL RS is determined as mentioned herein. In one example, a spatial relation configuration is provided as mentioned herein

In one example, the UE transmits the early SRS, or signal/channel triggering or indicating early SRS from UE to network, using the determined TCI state (e.g., using a spatial domain transmission filter based on the determined TCI state), wherein the TCI state is determined as mentioned herein.

In one example, the UE can transmit the early SRS, or signal/channel triggering or indicating early SRS from UE to network, using the more than one determined TCI state (e.g., using a spatial domain transmission filters based on the more than one determined TCI states), wherein the TCI states are determined as mentioned herein.

In one example, the UE transmits the early SRS, or signal/channel triggering or indicating early SRS from UE to network, using the determined spatial relation (e.g., using a spatial domain transmission filter based on the determined spatial relation), wherein the spatial relation is determined as mentioned herein.

In one example, the UE transmits the early SRS, or signal/channel triggering or indicating early SRS from UE to network using the more than one determined spatial relations (e.g., using a spatial domain transmission filter based on the more than one determined spatial relations), wherein the spatial relations are determined as mentioned herein.

In one example, the same spatial relation or TCI state is used for transmitting the signal/channel triggering or indicating early SRS from UE to network and for transmitting the early SRS. In one example, the UE determines the spatial relation or TCI state for the signal/channel triggering or indicating early SRS from UE to network, and uses that spatial relation or TCI state for early SRS.

one example, the different spatial relations or TCI states are used for transmitting the signal/channel triggering or indicating early SRS from UE to network and for transmitting the early SRS.

In one example, a UE determines the pathloss RS for measuring the DL pathloss and determining the transmit power of the early SRS, or the transmit power of the signal/channel triggering or indicating early SRS from UE to network.

In one example, the UE determines the pathloss RS based on the DL signal or DL RS (e.g., SSB or CSI-RS or LP-SS) that the UE determined, wherein the DL signal or DL RS is determined as mentioned herein. In one example, the pathloss RS is the determined DL signal or DL RS. In one example, the pathloss RS has a source RS (e.g., QCL Type D source RS of associated TCI state or source RS for spatial relation, direct or indirect) that is the determined DL signal or DL RS.

In one example, the PL RS and RS used to determine the spatial domain transmission filter (e.g., RS associated with TCI state or spatial relation) for early SRS (and/or the signal/channel triggering or indicating early SRS from UE to network) are associated with a same DL signal or DL RS (e.g., have a same source RS for spatial relation, direct or indirect).

In one example, the UE is configured a list of pathloss RS. In one example, the UE can be configured a list of pathloss in the early SRS configuration. In one example, the UE can be configured a list of pathloss RS in the SRS resource set configuration for early SRS and/or the signal/channel triggering or indicating early SRS from UE to network. In one example, the UE can be configured one or more pathloss RS in the SRS resource configuration for early SRS. In one example, the UE measures a quality metric of the pathloss reference signals and determines a pathloss reference signal based on the following examples.

In one example, the UE measures a quality of the pathloss (PL) RS provided as mentioned herein. In one example, the UE determines a quality metric, wherein the quality metric can be a reference signal receive power (RSRP), or signal to interference and noise ratio (SINR), or reference signal received quality (RSRQ) or other quality metrics. In one example, the quality metric can be based on a single measurement (e.g., based on a measurement of the PL RS in a time-unit, e.g., slot). In one example, the quality metric can be based on an average of multiple measurements, wherein a measurement of the multiple measurements is based on a measurement of the PL RS in a time-unit, e.g., slot. In one example, the average is a sliding window average within a time period T or a number of most recent instances N, wherein T and/or N can be configured or updated by SIB or RRC signaling and/or MAC CE signaling and/or L1 control (e.g., DCI Format) signaling.

In one example, the average is an exponential average e.g., if the quality metric in instance n is Q(n), and the quality metric in instance n−1 is Q(n−1) and measured quality metric in instance n is Qᵢₙₛ(n); Q(n)=αQ(n−1)+(1−α)Qᵢₙₛ(n) or (n)=(1−α)Q(n−1)+αQᵢₙₛ(n) wherein a, the exponential averaging coefficient, can be configured or updated by SIB and/or RRC signaling and/or MAC CE signaling and/or L1 control (e.g., DCI Format) signaling.

In one example, a UE determines a PL RS, with a quality metric, as mentioned herein that exceeds a threshold. In one example, the threshold can be configured or updated by SIB and/or RRC signaling and/or MAC CE signaling and/or L1 control (e.g., DCI Format) signaling.

In one example, a UE determines a PL RS, with a quality metric, as mentioned herein, the UE determines the M PL RS with the largest metrics. In one example, M can be configured or updated by SIB and/or RRC signaling and/or MAC CE signaling and/or L1 control (e.g., DCI Format) signaling. In one example, M=1, i.e., the UE determines the PL RS with the largest metric. In one example, M is specified in the system specifications.

In one example, a UE determines a PL RS, with a quality metric, as mentioned herein that exceeds a threshold M times during a time period T (e.g., used to start a timer) or during N instances (e.g., N consecutive instances), wherein the threshold and/or M and/or N and/or T can be configured or updated by SIB and/or RRC signaling and/or MAC CE signaling and/or L1 control (e.g., DCI Format) signaling.

In one example, the determined PL RS determines the spatial domain transmission filter the UE uses for early SRS (and/or the signal/channel triggering or indicating early SRS from UE to network). In one example, the determined PL RS determines the TCI state the UE uses for early SRS (and/or the signal/channel triggering or indicating early SRS from UE to network). In one example, the determined PL RS determines the spatial relation the UE uses for early SRS (and/or the signal/channel triggering or indicating early SRS from UE to network).

In one example, the PL RS is determined by the SSB with the same SSB index as the one the UE uses to determine the master information block (MIB).

In one example, the PL RS is determined by the SSB with the same SSB index as the one the UE uses to receive (e.g., based on QCL or spatial relation) system information block one (SIB1) or other SIB (e.g., with early SRS configuration).

In one example, the pathloss RS is included in or associated with a TCI state or spatial relation. The UE determines the TCI state or spatial relation as mentioned herein, and the UE uses the corresponding pathloss RS (e.g., included in or associated with the TCI state) to measure the DL pathloss.

In one example, the same pathloss RS is used for the determining the transmit power of the signal/channel triggering or indicating early SRS from UE to network and for determining the transmit power of the early SRS. In one example, the UE determines the pathloss RS for the signal/channel triggering or indicating early SRS from UE to network, and uses that pathloss RS for early SRS.

one example, the different pathloss RSes are used for the determining the transmit power of the signal/channel triggering or indicating early SRS from UE to network and for determining the transmit power of the early SRS.

In one example, a UE determines the power control parameters (e.g., p0 and/or alpha and/or closed loop power control adjustment state) for determining the transmit power of the early SRS and/or the signal/channel triggering or indicating early SRS from UE to network.

In one example, the UE is configured power control parameters (e.g., p0 and/or alpha and/or closed loop power control adjustment state). In one example, the UE can be configured power control parameters (e.g., p0 and/or alpha and/or closed loop power control adjustment state) in the early SRS configuration. In one example, the UE can be configured power control parameters (e.g., p0 and/or alpha and/or closed loop power control adjustment state) in the SRS resource set configuration for early SRS. In one example, the UE can be configured power control parameters (e.g., p0 and/or alpha and/or closed loop power control adjustment state) in the SRS resource configuration for early SRS. In one example, the UE can be configured power control parameters (e.g., p0 and/or alpha and/or closed loop power control adjustment state) in the configuration of the signal/channel triggering or indicating early SRS from UE to network.

In one example, the power control parameters (e.g., p0 and/or alpha and/or closed loop power control adjustment state) are included in or associated with a TCI state or spatial relation. The UE determines the TCI state or spatial relation as mentioned herein, and the UE uses the corresponding power control parameters (e.g., p0 and/or alpha and/or closed loop power control adjustment state) (e.g., included in or associated with the TCI state) to determine the transmit power of early SRS.

In one example, the power control parameters (e.g., p0 and/or alpha and/or closed loop power control adjustment state) are included in an early SRS resource. The UE determines and/or is indicated the early SRS resource, and the UE uses the corresponding power control parameters (e.g., p0 and/or alpha and/or closed loop power control adjustment state) to determine the transmit power of early SRS and/or of the signal/channel triggering or indicating early SRS from UE to network.

In one example, the power control parameters (e.g., p0 and/or alpha and/or closed loop power control adjustment state) are included in the resource of the signal/channel triggering or indicating early SRS from UE to network. The UE determines and is indicated the resource of the signal/channel triggering or indicating early SRS from UE to network, and the UE uses the corresponding power control parameters (e.g., p0 and/or alpha and/or closed loop power control adjustment state) to determine the transmit power of early SRS and/or of the signal/channel triggering or indicating early SRS from UE to network.

In one example, the same power control parameters (e.g., p0 and/or alpha and/or closed loop power control adjustment state) are used for the determining the transmit power of the signal/channel triggering or indicating early SRS from UE to network and for determining the transmit power of the early SRS. In one example, the UE determines the power control parameters (e.g., p0 and/or alpha and/or closed loop power control adjustment state) for the signal/channel triggering or indicating early SRS from UE to network, and uses these power control parameters (e.g., p0 and/or alpha and/or closed loop power control adjustment state) for early SRS.

one example, the different power control parameters (e.g., p0 and/or alpha and/or closed loop power control adjustment state) are used for the determining the transmit power of the signal/channel triggering or indicating early SRS from UE to network and for determining the transmit power of the early SRS.

In one example, the UE determines the transmission power of early SRS based on the following equation:

$${P}_{SRS , b , f , c} ( i , {q}_{s} , l ) = min \{ \begin{matrix}{P}_{CMAX , f , c} ( i ) , \\ {P}_{O \_ SRS , b , f , c} ( {q}_{s} ) + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i , l )\end{matrix} \} [ dBm ]$$

### Wherein,

i is the early SRS transmission occasion.
qₛ is the SRS resource set or the SRS resource for early SRS. In one example, qₛ can be related to the TCI state or spatial relation or pathloss RS used for early SRS.
l is the power control adjustment state.
b is the UL BWP.
f is the carrier used for early SRS.
c is the cell used for the transmission of early SRS.
P_{CMAX,f,c}(i) is the UE configured maximum output power defined in [8, TS 38.101-1], [8-2, TS 38.101-2], [TS 38.101-3] and [8-5, TS 38.101-5].
P_{O_SRS,b,f,c}(qₛ) is provided by p0 as mentioned herein based on early SRS resource set or early SRS resource or TCI state or spatial relation or pathloss RS used for early SRS.
M_{SRS,b,f,c}(i) is the SRS bandwidth for early SRS transmission occasion expressed in number of resource blocks.
α_{SRS,b,f,c}(qₛ) is provided by alpha as mentioned herein based on early SRS resource set or early SRS resource or TCI state or spatial relation or pathloss RS used for early SRS.
PL_{b,f,c}(q_{d}) is the downlink pathloss estimated in dB as mentioned herein by using RS index q_{d}, wherein q_{d} is determined as mentioned herein. In one example, q_{d} is related to TCI state or spatial relation or pathloss RS used for early SRS.
h_{b,f,c}(i, l) is the power control adjustment state, e.g., for closed loop power control. The power control adjustment can be determined as described in the following:

In one example, there is no power control adjustment state for early SRS. In this case, h_{b,f,c}(i, l)=0. Alternatively, the power control equation becomes:

$${P}_{SRS , b , f , c} ( i , {q}_{s} ) = min \{ \begin{matrix}{P}_{CMAX , f , c} ( i ) , \\ {P}_{O \_ SRS , b , f , c} ( {q}_{s} ) + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} )\end{matrix} \} [ dBm ]$$

In one example, there is a single power control adjustment state, e.g., l=0. In one example, the power control equation becomes:

$${P}_{SRS , b , f , c} ( i , {q}_{s} ) = min \{ \begin{matrix}{P}_{CMAX , f , c} ( i ) , \\ {P}_{O \_ SRS , b , f , c} ( {q}_{s} ) + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i )\end{matrix} \} [ dBm ]$$

Wherein, with TPC accumulation (TPC accumulation enabled) for early SRS,

$${h}_{b , f , c} ( i ) = {h}_{b , f , c} ( i - 1 ) + {\sum }_{m = 0}^{C ( {S}_{i} ) - 1} {δ}_{SRS , b , f , c} ( m ) ,$$

is a sum of TPC command values in a set Sᵢ of TPC command values with cardinality C(Sᵢ) that the UE receives between K_{SRS}(i−i₀)−1 symbols before SRS transmission occasion i−i₀ and K_{SRS}(i) symbols before SRS transmission occasion i on active UL BWP b of carrier f of serving cell c for SRS power control adjustment state, where i₀>0 is the smallest integer for which K_{SRS}(i−i₀) symbols before SRS transmission occasion i−i₀ is earlier than K_{SRS}(i) symbols before SRS transmission occasion i. K_{SRS}(i) can be determined as described in [REF 3].

Wherein, without TCP accumulation (TCP accumulation disable) for early SRS, h_{b,f,c}(i) δ_{SRS,b,f,c}(i).

In one example, the UE is configured to enable or disable TPC accumulation. In one example, TPC accumulation is enabled unless indicated otherwise. In one example, TPC accumulation is disabled unless indicated otherwise. In one example, the UE can be configured TPC accumulation according to the examples mentioned herein in the early SRS configuration. In one example, the UE can be configured TPC accumulation according to the examples mentioned herein in the SRS resource set configuration for early SRS. In one example, the UE can be configured TPC accumulation according to the examples mentioned herein in the SRS resource configuration for early SRS. In one example a same configuration of TPC accumulation is used in cells of the ESA. In one example, different TPC accumulation can be used in the cells of ESA.

δ_{SRS,b,f,c}(m) is a TPC command provided by dynamic signaling (e.g., MAC-CE or L1 control (e.g., DCI Format)). In one example, a UE in INACTIVE state or IDLE state is provided a configuration of dynamic signaling (e.g., MAC CE or DCI format) for TPC command.

In one example, there can be multiple power control adjustment states, e.g., two power control adjustment states, e.g., with l=0 and l=1.

Wherein, with TPC accumulation (TPC accumulation enabled) for early SRS,

$${h}_{b , f , c} ( i , l ) = {h}_{b , f , c} ( i - 1 , l ) + {\sum }_{m = 0}^{C ( {S}_{i} ) - 1} {δ}_{SRS , b , f , c} ( m , l ) ,$$

is a sum of TPC command values in a set Sᵢ of TPC command values, for power control adjustment state l with cardinality C(Sᵢ) that the UE receives between K_{SRS}(i−)−1 symbols before SRS transmission occasion i−i₀ and K_{SRS}(i) symbols before SRS transmission occasion i on active UL BWP b of carrier f of serving cell c for SRS power control adjustment state, where i₀>0 is the smallest integer for which K_{SRS}(i−i₀) symbols before SRS transmission occasion i−i₀ is earlier than K_{SRS}(i) symbols before SRS transmission occasion i. K_{SRS}(i) can be determined as described in [REF 3].

Wherein, without TCP accumulation (TCP accumulation disable) for early SRS,

$${h}_{b , f , c} ( i , l ) = {δ}_{SRS , b , f , c} ( i , l ) .$$

In one example, the UE is configured to enable or disable TPC accumulation. In one example, TPC accumulation is enabled unless indicated otherwise. In one example, TPC accumulation is disabled unless indicated otherwise. In one example, the UE can be configured TPC accumulation according to the examples mentioned herein in the early SRS configuration. In one example, the UE can be configured TPC accumulation according to the examples mentioned herein in the SRS resource set configuration for early SRS. In one example, the UE can be configured TPC accumulation according to the examples mentioned herein in the SRS resource configuration for early SRS. In one example a same configuration of TPC accumulation is used in cells of the ESA. In one example, different TPC accumulation can be used in the cells of ESA.

δ_{SRS,b,f,c}(m, l) is a TPC command provided by dynamic signaling (e.g., MAC-CE or L1 control (e.g., DCI Format)). In one example, a UE in INACTIVE state or IDLE state is provided a configuration of dynamic signaling (e.g., MAC CE or DCI Format) for TPC command. In one example, the channel (e.g., DCI Format or MAC CE) providing the TPC command indicates the corresponding power control adjustment state l. In one example, different channels (e.g., DCI Formats or MAC CEs) are configured for channel providing TPC command of different power control adjustment states l.

In one example, early SRS is transmitted in association with a random access procedure. In one example, the signal/channel triggering or indicating early SRS from UE to network is the PRACH preamble (e.g., Msg1 of type-1 random access procedure). In one example, the signal/channel triggering or indicating early SRS from UE to network is Msg3 of type-1 random access procedure.

In one example, in type-1 random access procedure, early SRS is transmitted after random access response (RAR). In one example, P_{O_SRS,b,f,c}(qₛ)=P_{O_PRE}+Δ_{PREAMBLE,SRS}, wherein Δ_{PREAMBLE,SRS} is a delta power level between the preamble power and the early SRS power.

In one example, the UE is configured Δ_{PREAMBLE,SRS}. In one example, the UE can be configured Δ_{PREAMBLE,SRS} in the early SRS configuration. In one example, the UE can be configured Δ_{PREAMBLE,SRS} in the SRS resource set configuration for early SRS. In one example, the UE can be configured Δ_{PREAMBLE,SRS} in the SRS resource configuration for early SRS. In one example a same configuration Δ_{PREAMBLE,SRS} is used in cells of the ESA. In one example, different Δ_{PREAMBLE,SRS} can be used in the cells of ESA.

In one example, P_{O_PRE} is preamble power, e.g., preamble power of the last instance of the preamble transmitted before the early SRS.

In one example, the early SRS transmit power associated type-1 random access procedure is provided by:

$${P}_{SRS , b , f , c} ( i , {q}_{s} , l ) = min \{ \begin{matrix}{P}_{CMAX , f , c} ( i ) , \\ {P}_{O \_ PRE} + {Δ}_{PREAMBLE , SRS} + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i , l )\end{matrix} \} [ dBm ]$$

In one example, h_{b,f,c}(i=0, 1)=0, wherein instance i=0 is the first instance of early SRS transmitted after the RAR. In one example, an additional power offset can be indicated in the RAR, e.g., Δ_{RAR}, and h_{b,f,c}(i=0, 1)=Δ_{RAR}.

In one example, there is no power control adjustment state for early SRS. In this case, h_{b,f,c}(i, l)=0. Alternatively, the power control equation becomes:

$${P}_{SRS , b , f , c} ( i , {q}_{s} ) = min \{ \begin{matrix}{P}_{CMAX , f , c} ( i ) , \\ {P}_{O \_ PRE} + {Δ}_{PREAMBLE , SRS} + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} )\end{matrix} \} [ dBm ]$$

In one example, there is no power control adjustment state for early SRS and an additional power offset can be indicated in the RAR, e.g., Δ_{RAR}. In this case, h_{b,f,c}(i, l)=Δ_{RAR}. Alternatively, the power control equation becomes:

$${P}_{SRS , b , f , c} ( i , {q}_{s} ) = min \{ \begin{matrix}{P}_{CMAX , f , c} ( i ) , \\ {P}_{O \_ PRE} + {Δ}_{PREAMBLE , SRS} + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} ) + {Δ}_{RAR}\end{matrix} \} [ dBm ]$$

In one example, there is a single power control adjustment state, e.g., l=0. In one example, the power control equation becomes:

$${P}_{SRS , b , f , c} ( i , {q}_{s} ) = min \{ \begin{matrix}{P}_{CMAX , f , c} ( i ) , \\ {P}_{O \_ PRE} + {Δ}_{PREAMBLE , SRS} + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i )\end{matrix} \} [ dBm ]$$

In on example, h_{b,f,c}(i=0)=0, wherein instance i=0 is the first instance of early SRS transmitted after the RAR. In one example, an additional power offset can be indicated in the RAR, e.g., Δ_{RAR}, and h_{b,f,c}(i=0)=Δ_{RAR}.

In one example, in type-1 random access procedure, P_{O_SRS,b,f,c}(qₛ)=P_{O_MSG3}+Δ_{MSG3,SRS}, wherein Δ_{MSG3,SRS} is a delta power level between the MSG3 and the early SRS power. In one example, P_{O_MSG3} is Msg3 power, e.g., Msg3 power of the last instance of the Msg3 transmitted before the early SRS.

In one example, the UE is configured Δ_{MSG3,SRS}. In one example, the UE can be configured Δ_{MSG3,SRS} in the early SRS configuration. In one example, the UE can be configured Δ_{MSG3,SRS} in the SRS resource set configuration for early SRS. In one example, the UE can be configured Δ_{MSG3,SRS} in the SRS resource configuration for early SRS. In one example a same configuration Δ_{MSG3,SRS} is used in cells of the ESA. In one example, different Δ_{MSG3,SRS} can be used in the cells of ESA.

In one example, in type-2 random access procedure, early SRS is transmitted in MsgA with a preamble or is transmitted after MsgA. In one example, the signal/channel triggering or indicating early SRS from UE to network is the PRACH preamble (e.g., MsgA PRACH of type-2 random access procedure). In one example, the signal/channel triggering or indicating early SRS from UE to network is MsgA PUSCH of type-2 random access procedure. Early SRS transmission can be in addition to or instead of MsgA PUSCH. In one example, P_{O_SRS,b,f,c}(qₛ)=P_{O_PRE}+Δ_{MsgA_SRS}, wherein Δ_{MsgA_SRS} is a delta power level between the preamble power and the early SRS power of MsgA.

In one example, the UE (e.g., the UE 116) is configured Δ_{MsgA_SRS}. In one example, the UE can be configured Δ_{MsgA_SRS} in the early SRS configuration. In one example, the UE can be configured Δ_{MsgA_SRS} in the SRS resource set configuration for early SRS. In one example, the UE can be configured Δ_{MsgA_SRS} in the SRS resource configuration for early SRS. In one example a same configuration Δ_{MsgA_SRS} is used in cells of the ESA. In one example, different Δ_{PREAMBLE,SRS} can be used in the cells of ESA.

In one example, P_{O_PRE} is preamble power, e.g., preamble power of the last instance of the preamble transmitted before the early SRS.

In one example, the early SRS transmit power associated type-2 random access procedure is provided by:

$${P}_{SRS , b , f , c} ( i , {q}_{s} , l ) = min \{ \begin{matrix}{P}_{CMAX , f , c} ( i ) , \\ {P}_{O \_ PRE} + {Δ}_{MsgA \_ SRS} + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i , l )\end{matrix} \} [ dBm ]$$

In one example, h_{b,f,c}(i=0, l)=0, wherein instance i=0 is the first instance of early SRS transmitted in MsgA or after the preamble.

In one example, there is no power control adjustment state for early SRS. In this case, h_{b,f,c}(i, l)=0. Alternatively, the power control equation becomes:

$${P}_{SRS , b , f , c} ( i , {q}_{s} ) = min \{ \begin{matrix}{P}_{CMAX , f , c} ( i ) , \\ {P}_{O \_ PRE} + {Δ}_{MsgA \_ SRS} + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} )\end{matrix} \} [ dBm ]$$

In one example, there is a single power control adjustment state, e.g., l=0. In one example, the power control equation becomes:

$${P}_{SRS , b , f , c} ( i , {q}_{s} ) = min \{ \begin{matrix}{P}_{CMAX , f , c} ( i ) , \\ {P}_{O \_ PRE} + {Δ}_{MsgA \_ SRS} + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i )\end{matrix} \} [ dBm ]$$

In one example, h_{b,f,c}(i=0)=0, wherein instance i=0 is the first instance of early SRS transmitted in MsgA or after the preamble.

In one example, in type-1 random access procedure, P_{O_SRS,b,f,c}(qₛ)=P_{O_MSGAPUSCH}+Δ_{MSGAPUSCH,SRS}, wherein Δ_{MSGAPUSCH,SRS} is a delta power level between the MSGA PUSCH and the early SRS power. In one example, P_{O_MSGAPUSCH} is MsgA PUSCH power, e.g., MsgA PUSCH power of the last instance of the MsgA PUSCH transmitted before the early SRS

In one example, the UE is configured Δ_{MSGAPUSCH,SRS}. In one example, the UE can be configured Δ_{MSGAPUSCH,SRS} in the early SRS configuration. In one example, the UE can be configured Δ_{MSGAPUSCH,SRS} in the SRS resource set configuration for early SRS. In one example, the UE can be configured Δ_{MSGAPUSCH,SRS} in the SRS resource configuration for early SRS. In one example a same configuration Δ_{MSGAPUSCH,SRS} is used in cells of the ESA. In one example, different Δ_{MSG3,SRS} can be used in the cells of ESA.

In the aforementioned, examples, the early SRS can be replaced by an early CSI report on PUSCH. The same examples apply for the configuration of a channel or signal triggering or indicating the transmission of early CSI in a PUSCH from the UE or the network, or channel from the network to the UE to trigger or indicate or schedule the transmission of early CSI in a PUSCH. The same examples apply for the spatial relation or TCI state of the PUSCH channel carrying early CSI report or the transmit power of the PUSCH channel carrying early CSI report.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to receive a configuration related to sounding a reference signal (SRS), wherein the configuration indicates:
a list of downlink (DL) signals associated with one or more cells,
SRS resources, and
an association between the DL signals and the SRS resources; and
a processor operably coupled to the transceiver, the processor configured to:
measure and determine a DL signal from the DL signals, and
determine, from the SRS resources, an SRS resource associated with the DL signal,
wherein the transceiver is further configured to:
transmit an uplink (UL) signal associated with the determined SRS resource, and
transmit the SRS resource based on the UL signal.

2. The UE of claim 1, wherein:
the DL signal is a synchronization signal/physical broadcast channel (SS/PBCH) block (SSB),
the list of DL signals is based on a list of physical channel identities (PCIs) in corresponding SSBs, and
the determination of the DL signal is based on a comparison of a reference signal received power (RSRP) with a threshold.

3. The UE of claim 1, wherein the UL signal is a physical random access channel (PRACH) preamble or a physical uplink shared channel (PUSCH) associated with the PRACH preamble.

4. The UE of claim 1, wherein the transmission of the UL signal and the SRS resource is based on a same spatial domain transmission filter.

5. The UE of claim 1, wherein the transmission of the SRS resource is based on a spatial domain reception filter used for the DL signal.

6. The UE of claim 1, wherein the transmission of the SRS resource is based on a transmit power used for the UL signal.

7. The UE of claim 1, wherein a transmit power for the transmission of the SRS resource is based on a pathloss RS associated with the DL signal.

8. A base station (BS), comprising:
a processor; and
a transceiver operably coupled to the processor, the transceiver configured to:
transmit a configuration related to a sounding reference signal (SRS), wherein the configuration indicates:
a list of downlink (DL) signals associated with one or more cells,
SRS resources, and
an association between the DL signals and the SRS resources,
receive an uplink (UL) signal associated with an SRS resource, and
receive the SRS resource based on the UL signal.

9. The BS of claim 8, wherein:
a DL signal, from the DL signals, is a synchronization signal/physical broadcast channel (SS/PBCH) block (SSB),
the list of DL signals is based on a list of physical channel identities (PCIs) in corresponding SSBs, and
determination of the DL signal is based on a comparison of a reference signal received power (RSRP) with a threshold.

10. The BS of claim 8, wherein the UL signal is a physical random access channel (PRACH) preamble or a physical uplink shared channel (PUSCH) associated with the PRACH preamble.

11. The BS of claim 8, wherein transmission of the UL signal and the SRS resource is based on a same spatial domain transmission filter.

12. The BS of claim 8, wherein the reception of the SRS resource is based on a spatial domain transmission filter used for the DL signal.

13. The BS of claim 8, wherein transmission of the SRS resource is based on a transmit power used for the UL signal.

14. The BS of claim 8, wherein a transmit power for transmission of the SRS resource is based on a pathloss RS associated with the DL signal associated with the SRS.

15. A method of operating a user equipment (UE), the method comprising:
receiving a configuration related to a sounding reference signal (SRS), wherein the configuration indicates:
a list of downlink (DL) signals associated with one or more cells,
SRS resources, and
an association between the DL signals and the SRS resources;
measuring and determining a DL signal from the DL signals;
determining, from the SRS resources, an SRS resource associated with the DL signal;
transmitting an uplink (UL) signal associated with the determined SRS resource; and
transmitting the SRS resource based on the UL signal.

16. The method of claim 15, wherein:
the DL signal is a synchronization signal/physical broadcast channel (SS/PBCH) block (SSB),
the list of DL signals is based on a list of physical channel identities (PCIs) in corresponding SSBs, and
the determination of the DL signal is based on a comparison of a reference signal received power (RSRP) with a threshold.

17. The method of claim 15, wherein the UL signal is a physical random access channel (PRACH) preamble or a physical uplink shared channel (PUSCH) associated with the PRACH preamble.

18. The method of claim 15, wherein the transmission of the UL signal and the SRS resource is based on a same spatial domain transmission filter.

19. The method of claim 15, wherein the transmission of the SRS resource is based on a spatial domain reception filter used for the DL signal.

20. The method of claim 15, wherein a transmit power for the transmission of the SRS resource is based on:
transmit power used for the UL signal, and
a pathloss RS associated with the DL signal.
